(19) United States
(12) Patent Application Publication
(10) Pub. No.: US 2025/0355433 A1
(43) Pub. Date: Nov. 20, 2025

(54) Systems and Methods for Energy Saving, Self-Diagnosis, and Predictive Maintenance in Manufacturing Machines

(71) Applicant: The Regents of The University of California, Oakland, CA (US)

(72) Inventors: Guann Pyng Li, Irvine, CA (US); Yimin Wang, Irvine, CA (US); Yutian Ren, Irvine, CA (US); Jake J Hes, Whittier, CA (US); Paul E Bautista, Carson, CA (US); Mo Kebaili, Irvine, CA (US)

(73) Assignee: The Regents of The University of California, Oakland, CA (US)

(21) Appl. No.: 19/207,770

(22) Filed: May 14, 2025

Related U.S. Application Data
(60) Provisional application No. 63/647,280, filed on May 14, 2024.

(51) Int. Cl. G05B 23/02

(52) U.S. Cl. CPC G05B 23/0283; G05B 23/021; G05B 23/0275

(57) ABSTRACT

Systems and methods for identifying degradation in performance of manufacturing machines are disclosed. The method includes enabling the manufacturing machine to transition to sleep mode wherein the manufacturing machine executes at least one predefined diagnostic operation in the sleep mode. The method includes invoking the manufacturing machine to execute at least one predefined diagnostic operation in the sleep mode. The method includes receiving data generated in response to the execution of at least one predefined diagnostic operation by the manufacturing machine in the sleep mode. The method includes identifying the degradation in performance of the manufacturing machine when the value of the data is less than a lower boundary value of a predefined range of values for the data or the value of the data is greater than an upper boundary value of the predefined range of values for the data.

### PRIORITY APPLICATION

This application claims the benefit of U.S. Patent Application No. 63/647,280, entitled “SYSTEMS AND METHODS FOR ENERGY SAVING, SELF-DIAGNOSIS, AND PREDICTIVE MAINTENANCE IN MANUFACTURING MACHINES,” filed on May 14, 2024 (Attorney Docket No. UCI1009USP01). The provisional patent application is incorporated by reference for all purposes.

### STATEMENT REGARDING FEDERALLY SPONSORED RESEARCH OR DEVELOPMENT

This invention was made with Government support under Agreement No. N00164-19-9-0001, awarded by NSWC Crane Division. The Government has certain rights in the invention.

### FIELD OF THE TECHNOLOGY DISCLOSED

The technology disclosed artificial intelligence type computers and digital data processing systems and corresponding data processing methods and products for emulation of intelligence (i.e., knowledge-based systems, reasoning systems, and knowledge acquisition systems); and including systems for reasoning with uncertainty (e.g., fuzzy logic systems), adaptive systems, machine learning systems, and artificial neural networks. In particular, the technology disclosed is related to machine learning and artificial intelligence-based techniques for predictive maintenance of machines.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

### DESCRIPTION OF RELATED ART

Existing maintenance practices for manufacturing machines have various limitations. In a first maintenance practice, the maintenance is typically performed when deficiencies are observed in performance of the manufacturing machine or issues are observed in output produced from the manufacturing machines. In this case, maintenance is performed only after failure occurs. In another maintenance practice, the machine's maintenance is performed at a pre-defined schedule. In this case, unexpected machine breakdowns can happen if an abnormal event causes sudden change in machine's condition.

Therefore, an opportunity arises to develop systems and methods for maintenance of manufacturing machines that can address the above-mentioned limitations of existing maintenance practices.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which.

FIG. 1 presents an architectural-level schematic of a system in accordance with one implementation of the technology disclosed.

FIG. 2 presents an architectural-level schematic of the system in accordance with another implementation of the technology disclosed.

FIG. 3 presents an architectural-level schematic illustrating components of the system in accordance with one implementation of the technology disclosed.

FIG. 4 presents an architectural-level schematic illustrating components of the system in accordance with another implementation of the technology disclosed.

FIG. 5 presents an example process flow diagram illustrating process steps for sleep-mode diagnosis.

FIG. 6 presents a system diagram for worker-machine-material interaction in accordance with one implementation of the technology disclosed.

FIG. 7 presents an example process flow diagram for worker-machine-material interaction as shown in FIG. 6.

FIG. 8 presents an example process flow diagram for active mode anomaly detection in accordance with one implementation of the technology disclosed.

FIG. 9 presents a graphical illustration of comparison of original standby model and sleep mode as implemented by the technology disclosed.

FIG. 10 presents an example process flow diagram illustrating process operations for sleep mode control in accordance with one implementation of the technology disclosed.

FIG. 11A presents an example of root cause analysis using a fishbone diagram.

FIG. 11B presents a high-level architecture of information management in sleep mode self-diagnosis.

FIG. 12 presents an example process flow diagram illustrating process operations for sleep mode diagnosis in accordance with one implementation of the technology disclosed.

FIGS. 13A, 13B, 13C and 13D present graphs illustrating raw values of machine conditions over time.

FIG. 14 presents graphs illustrating machine learning prediction comparison of machine conditions based on sleep mode data.

FIG. 15 presents a graph illustrating machine condition variation over time.

FIG. 16 shows an example of a computer system that can be used to implement the technology disclosed.

### DETAILED DESCRIPTION

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

The following detailed description is made with reference to the figures. Example implementations are described to illustrate the technology disclosed, not to limit its scope, which is defined by the claims. Those of ordinary skill in the art will recognize a variety of equivalent variations on the description that follows. Reference will now be made in detail to the exemplary implementations of the present disclosure, examples of which are illustrated in the accompanying drawings. Wherever possible, the same reference numbers will be used throughout the drawings to refer to the same or like parts.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The detailed description of various implementations will be better understood when read in conjunction with the appended drawings. To the extent that the figures illustrate diagrams of the functional blocks of the various implementations, the functional blocks are not necessarily indicative of the division between hardware circuitry. Thus, for example, one or more of the functional blocks (e.g., modules, processors, or memories) may be implemented in a single piece of hardware (e.g., a general-purpose signal processor or a block of random-access memory, hard disk, or the like) or multiple pieces of hardware. Similarly, the programs may be stand-alone programs, may be incorporated as subroutines in an operating system, may be functions in an installed software package, and the like. It should be understood that the various implementations are not limited to the arrangements and instrumentality shown in the drawings.

The processing engines and databases of the figures, designated as modules, can be implemented in hardware or software, and need not be divided up in precisely the same blocks as shown in the figures. Some of the modules can also be implemented on different processors, computers, or servers, or spread among a number of different processors, computers, or servers. In addition, it will be appreciated that some of the modules can be combined, operated in parallel or in a different sequence than that shown in the figures without affecting the functions achieved. The modules in the figures can also be thought of as flowchart steps in a method. A module also need not necessarily have all its code disposed contiguously in memory; some parts of the code can be separated from other parts of the code with code from other modules or other functions disposed in between.

### INTRODUCTION

The technology disclosed provides systems and methods to monitor the manufacturing machine's integrity and performance, detect potential machine failures, and determine causes of failures, thus, to assist users in conducting predictive maintenance and enhance manufacturing process. The technology disclosed also comprises utilization of the method for implementation of intelligent machine possessing the aforementioned functions.

The technology disclosed utilizes machine learning algorithms with the content sensors installed on the machine to capture contextual information as a contextual sensor, which can monitor the users' operations during active mode and detect anomalies. In addition to collecting process parameters during the active mode, the technology disclosed also collects data that indicate machine conditions and exclude direct human influence by modifying the original standby mode to a sleep mode. Machine self-diagnosis can be triggered during sleep mode to identify degradations of machine. This self-diagnosis mode can also determine potential causes of the identified degradations by finding the correlations among data collected during sleep modes, process parameters collected during active modes, and anomalies detected during active modes.

The technology disclosed provides a knowledge-based (such as fishbone diagram) self-diagnosis method for managing manufacturing process. The technology disclosed provides systems and methods to explore the states of worker-machine-material interaction by adopting a novel soft mode-switch mechanism to categorize machine operation into active and sleep modes and a machine learning algorithm based on machine Standard Operation Procedure (SOP). New predictive functions in managing manufacturing process are provided for diagnosis of worker-machine-materials interaction in active mode, self-diagnosis of machine's integrity in sleep mode, and self-repairment of machine functions based on these predictions.

The technology disclosed enables a holistic self-diagnosis system that can be implemented with an existing Programmable Logic Controllers (PLC) used for automation and control as illustrated in this record of technology disclosed. The technology disclosed allows implementation of the self-diagnosis system by complementing an existing PLC with external industry Internet of Things (IoT) sensors and actuators, and allows augmented control with an external system for a manual tool without PLC.

Manufacturing machines are widely used in various industries and usually alternate between two different states, referred to as an active mode and a standby mode. In the active mode, the manufacturing machines are engaged in manufacturing tasks (also referred to as manufacturing operations) to process materials, while in standby mode, they usually maintain an idle state waiting for commands from users (or operators). Multiple sensors can be installed on a machine for collecting various process parameters, such as pressure, temperature, power, etc. Users usually only focus on those process parameters during the machine's active mode since they measure the machine's conditions in conducting manufacturing tasks (or manufacturing operations) and may affect product quality. Users are less concerned about process parameters that are collected during the standby mode since the machine does not perform any action (or operation) during the standby mode and the process parameters are usually maintained consistently.

There are two traditional maintenance practices used for manufacturing machines. In a first maintenance practice, the maintenance of machines usually relies on raw data from sensors. Users can conduct maintenance after observing certain process parameters reach the thresholds that are determined based on their manufacturing knowledge, which indicates that the machine cannot ensure consistent performance and/or product quality. The limitation of this maintenance protocol is that users can only take actions after failures occur, which may lead to longer machine downtime. A second maintenance practice for the maintenance of machines is referred to as scheduled maintenance. In this case, users may estimate the rate of aging in the machine's components based on their experience and perform maintenance after a certain time interval. The limitation of the scheduled maintenance is that unexpected machine breakdowns may happen if some abnormal events cause the abrupt changes in machine's conditions. It may also introduce unnecessary maintenance costs if the machine's aging rate is slower than the estimation.

Besides the limitations mentioned above, these two traditional maintenance practices also require users to spend significant time to find the cause of machine failures. Therefore, the technology disclosed provides systems and methods for monitoring machine conditions, detecting degradations in machine's integrity and performance, determining potential causes of machine failures and enables a new predictive maintenance practice.

The technology disclosed provides an innovative method designed to monitor the manufacturing machine's integrity and performance, detect potential machine failures, and determine causes of failures, thus, to assist users in conducting predictive maintenance and enhance manufacturing process. The technology disclosed also enables utilization of the method for implementation of intelligent machine possessing the aforementioned functions.

The technology disclosed utilizes machine learning algorithms with the content sensors installed on the machine to capture contextual information as a contextual sensor, which can monitor the users' operations during active mode and detect anomalies. In addition to collecting process parameters during the active mode, the technology disclosed can also collect data that indicate machine conditions. The technology disclosed allows exclusion of direct human influence by modifying the original standby mode to a new proposed sleep mode. Machine self-diagnosis can be triggered during sleep mode to identify degradations of machine. This self-diagnosis mode can also determine potential causes of the identified degradations by finding the correlations among data collected during sleep modes, process parameters collected during active modes, and anomalies detected during active modes.

This technology disclosed provides systems and methods for self-diagnosis on manufacturing machines (hereinafter referred to as “machines”) to realize a range of functions that include but are not limited to detecting operational states of machines, detecting anomalies in operations, monitoring the machine's integrity and performance, detecting potential machine failures, and determining causes of failures. The machines mentioned herein include but are not limited to deposition and etching machines used in semiconductor manufacturing such as Reactive Ion Etching (RIE), Chemical Vapor Deposition (CVD), evaporation and sputtering systems. The method of knowledge-based self-diagnosis of manufacturing process illustrated in this disclosure can be equally applicable for manufacturing industries other than semiconductor manufacturing.

### Control Interfaces of Machines

Manufacturing machines may have different control interfaces. Programmable Logic Controllers (PLCs) are widely used nowadays to achieve automatic control. For the machine equipped with PLC, workers can trigger the preset commands, and PLC will control different components following the predefined program to accomplish workers' commands. The PLC may control various components, such as pumps, valves, motors, heaters, and radio frequency plasma generators, and may monitor various process parameters, such as temperature, pressure, power, noise, and vibration, through different content sensors.

For the machine without a PLC, workers can control the machine's individual components manually according to the measurement from preinstalled content sensors on the machine. The technology disclosed provides systems and methods for predictive maintenance of both types of machines.

### Operational Modes of Machine (Active Mode and Standby Mode)

Manufacturing machines can operate in two distinct modes, commonly referred to as “active mode” and “standby mode”. The transition between modes occurs based on whether the machine is engaged in manufacturing tasks. In the active mode, a worker operates the machine to process materials. During this active mode, the machine's various components are controlled either manually by the worker or automatically by the PLC in response to commands from the worker. Standby mode occurs when the machine is not involved in manufacturing tasks. During the standby mode, the machine is maintained at an idle state, awaiting instructions or tasks to be initiated.

### Standard Operating Procedure

In general, a machine's operational sequences or workflows during active mode are documented as the standard operating procedure (SOP) for workers to follow to control the machine. SOP is a set of step-by-step instructions compiled by an organization to help employees carry out routine operations. SOPs are designed to ensure consistency, efficiency, and compliance with regulations or organizational standards. They are commonly used in various industries such as healthcare, manufacturing, aviation, and information technology to ensure that tasks are performed correctly and consistently, regardless of who is carrying them out. SOPs typically outline the necessary steps, materials, equipment, and safety precautions required to complete a specific task or process. SOPs are usually developed based on human knowledge and experience.

For example, a simplified SOP of a silicon etching machine used in semiconductor manufacturing can be described as follows:
1) vent the chamber to atmosphere.
2) open the chamber to load the sample in.
3) pump down the chamber to base pressure.
4) select an etch recipe and run the etching process by activating radio frequency generator and adding gases in the chamber.
5) vent the chamber to atmosphere.
6) open the chamber to unload the sample out.
7) pump down the process chamber to base pressure for machine to enter the standby mode.

During this procedure, steps 1, 3, 4, 5, and 7 require the worker to operate the keyboard for sending commands and require the machine to process the sample and gases inside the process chamber. Steps 2 and 6 require workers to operate the chamber and move the sample.

### Worker-Machine-Material Interaction

The workflow defined in the SOP can be represented as multiple sequential or parallel interaction events between the worker, machine, and material. The worker-machine interactions include but are not limited to sending commands through the keyboard and opening and closing the process chamber. The worker-material interactions include but are not limited to moving, inspecting, and cleaning materials. Machine-material interactions include but are not limited to heating materials, removing gases from the chamber, adding gases to the chamber, waste deposit on machines, and producing new material.

Using the silicon etching SOP mentioned above as an example. Step 2 and step 6 involve worker-machine interactions and worker-material interactions. Steps 1, 3, 5, and 7 involve worker-machine interactions firstly for sending commands, then machine-material interactions happen for adding or removing gases. Step 4 requires the worker to interact with the machine first, then multiple machine-material interactions can happen in parallel.

### Four Function Modules of the Technology Disclosed

The technology disclosed describes systems and methods of machine self-diagnosis functions in both active mode and sleep mode based on prior established knowledge in the form of fishbone diagrams to identify anomalous events and root causes of anomalous events so that new cause-effect relationships can be added to the fishbone diagrams for future root cause analysis. The proposed system consists of four function modules that are defined as below.

The first module is a worker-machine-material interaction detection (WMM) module. Details of the logic implemented in WMM module are presented below.

WMM module can capture and detect contextual information from sensors' signals. By processing the content sensors data streams from sensors or PLCs using statistical or machine learning models, WMM can detect the occurrence of interactions between workers, machines, and materials. Based on the detected interactive events, WMM can identify the real-time status of workers, machines (e.g., operational modes), and materials. When the machine is in active mode, WMM can also monitor the progress of operation by detecting the sequence of interactive events and duration of each event (hereinafter referred to as “time interval”). The sequences and time intervals of interactive events are saved for further analysis and application in the self-diagnosis. The interactive events can be steps or segments performed as part of a manufacturing operation or manufacturing task. While the manufacturing machine is in active mode, it can perform one or more manufacturing operations or manufacturing tasks. A manufacturing operation or a manufacturing task can have one or more segments. Each step or segment may have a predefined duration or time interval between the start time of the segment and an end time of the segment. An SOP can include these details for each step or segment of a manufacturing operation. During active mode when the manufacturing task or the manufacturing operation is executed or performed by the manufacturing machine, the actual duration of each step or segment can be recorded and compared with the planned duration of the same step or segment as defined in the SOP.

During the active mode, the content sensors data itself can also provide valuable information about the machine's process conditions. The WMM module also records all the data captured or measured by sensors that are installed on the machine as the process parameters to evaluate the active mode performance. The data may include but is not limited to power, pressure, temperature, noise, vibration, humidity, types of materials, and gas flow rate. The sensors may be pre-installed and can transmit data to the PLC so that the WMM module can collect data from the PLC. The sensors may be additionally installed together with the proposed system and directly transmit data to the WMM.

The second module is referred to as an Active Mode Anomaly Detection (AMAD) module, which serves to identify and report anomalies during the machine's active mode. AMAD module comprises logic to compare the sequence of interactive events for the current manufacturing operation or manufacturing task, as detected by the WMM module, with the authentic operation sequence predefined in the SOP. Additionally, the AMAD module comprises logic to compare the time intervals of each interactive event (also referred to as steps or segments in a manufacturing operation) with pre-characterized time intervals. Consequently, AMAD module can detect deviations from the SOP in the sequence of the worker's operations, as well as deviations in the time intervals of certain steps. These deviations can be identified as active mode anomalies caused by worker operations. This feature of the AMAD module can assist in evaluating the worker's performance in conducting manufacturing tasks, finding mistakes, and can be utilized for personalized worker training.

AMAD module can also intake the raw process parameters collected by WMM module during manufacturing operations of the manufacturing machine in the active mode. The normal range of each parameter may be determined through statistical methods, machine learning algorithms, or human knowledge and experience. The AMAD module may detect whether any parameter is out of its normal range and identify that as active mode anomalies.

The third module is referred to as a Sleep Mode Control (SMC) module. According to the operational modes detected by the WMM module, the Sleep Mode Control module can activate a sleep mode during a machine's original standby mode and deactivate the sleep mode when the machine switches to active mode to ensure manufacturing processes are uninterrupted. This newly introduced sleep mode by the technology disclosed differs from the original standby mode in that, during sleep mode, SMC module can intentionally control the machine to perform some predefined actions also referred to as diagnostic operations or diagnostic tasks to collect information related to machine health by analyzing sensor or PLC data. Since those actions are fully controlled by the logic implemented as part of the SMC module's software and exclude active mode interaction, the data collected during sleep mode is consistent over time if the machine is always kept in normal condition.

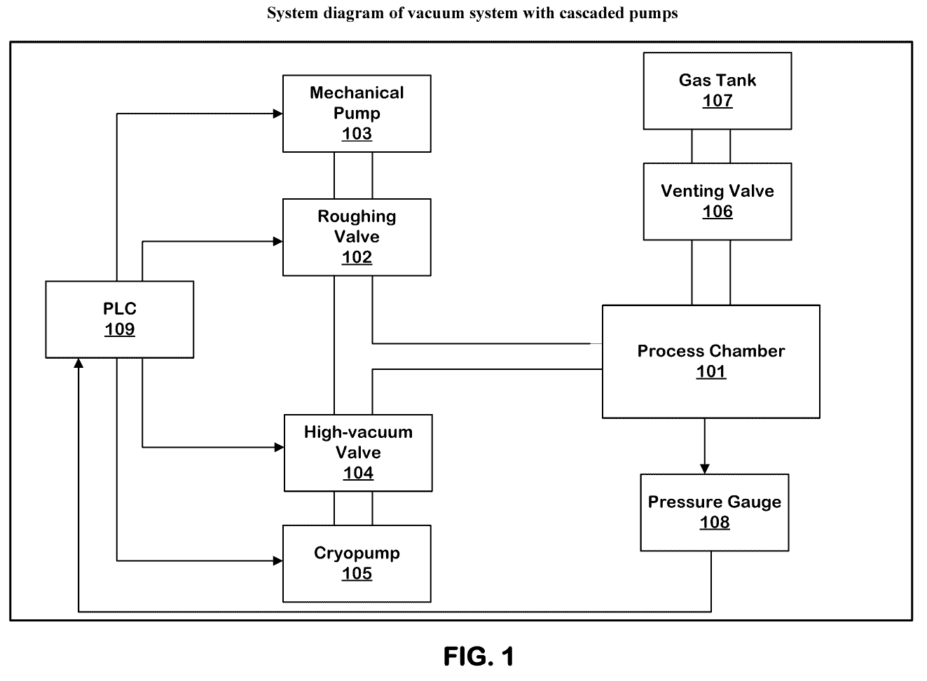

The details of the SMC module on machines equipped with vacuum system is provided as an example. This machine utilizes both mechanical pump and cryopump as shown in FIG. 1. The system in FIG. 1 includes a PLC 109. When the sleep mode is activated by SMC on this machine and the chamber reaches the base pressure, the SMC module can close the high-vacuum valve 104 allowing the chamber pressure to increase to a preset pressure level. Once the chamber pressure reaches the preset pressure level, SMC module opens the high-vacuum valve 104 to pump down the chamber 101 (also referred to as process chamber 101) back to the base pressure using the cryopump. A pressure gauge 108 is connected to the process chamber 101. The SMC module can also control the machine to vent the chamber to the atmospheric pressure by opening venting valve 106, then pump down the chamber to the crossover pressure using the mechanical pump 103, followed by further pumping down the chamber to the base pressure using the cryopump 105. The venting valve is connected to a gas tank 107. The SMC module can collect the pressure data during this sleep mode and compute the change rate of pressure in each segment of a manufacturing operation. Another example illustrates a machine comprising only one mechanical pump utilized for vacuum system in the machine. In this configuration, the pressure increase, and decrease are controlled by roughing valve 102. The example in FIG. 1 illustrates examples of diagnostic operations such as increasing and/or decreasing pressure in various parts or components of the machine. The diagnostic operations also include computing change rate of pressure in various components of the machine during different segments of the manufacturing operation. Other examples of diagnostic operations include determining abrupt changes in pressure in any component of the machine. The technology disclosed includes logic to compare change rate of pressure in a component with a predefined threshold and if the change rate of pressure is more than the predefined threshold for the given component then it is determined that the change rate of pressure is abrupt. In the following sections, more details are presented on the next steps performed by the technology disclosed when abrupt changes in pressure are determined to identify the cause of an abrupt change.

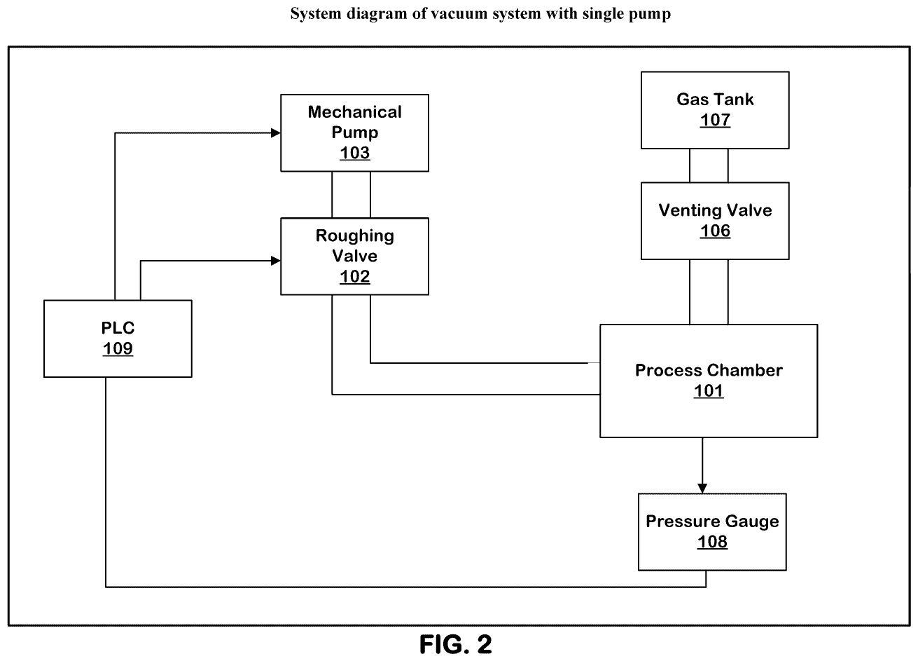

FIG. 2 presents system diagram of vacuum system with single pump. The system diagram of FIG. 2 is similar to system diagram in FIG. 1 except that it does not include high-vacuum valve 104 and cryopump 105.

The fourth module provided by the technology disclosed is referred to as a Sleep Mode Self-Diagnosis (SMSD) module. The SMSD module comprises logic to identify the degradations in the machine's integrity and performance and assist in determining the potential causes of degradations.

SMSD module identifies anomalous events (i.e., sleep mode anomalies) by analyzing whether the sleep mode data provided by SMC module during the current sleep mode are within the normal range. The SMSD module comprises logic to intake outputs from AMAD module to check if any active mode anomalies had been detected during all active modes occurred in between the current sleep mode and last sleep mode. The active mode anomalies may include workers' operations deviations from the SOP, and/or process parameters deviations from normal ranges. SMSD module comprises logic to determine the detected active mode anomalies as the potential cause of observed sleep mode anomalies. Over time, more potential cause-effect correlations may be discovered by SMSD module, which can assist personnel in reducing the time cost for finding root causes and improving the process quality.

SMSD module comprises logic to analyze historical sleep mode data to evaluate the changes in machine's conditions over time and determine how they relate to machine usage. Machine usage can be represented as a number of times the manufacturing machine is used in active mode and/or in sleep mode over a pre-defined period of time such as one day, one week, one month, six months, one year, or more. Machine usage can also be represented as a time duration in active mode and/or sleep mode over the pre-defined period of time such as one day, one week, one month, six months, one year, or more. This allows maintenance personnel to monitor the machine's condition and perform predictive maintenance.

### Two Implementations (PLC/No PLC)

The four function modules introduced above can be implemented differently depending on the machine's control interface, which can be categorized into 3 types. The first type of machine is controlled by a PLC that users can modify and reprogram. The second type of machine is controlled by a PLC, but the PLC is proprietary and cannot be accessed or reprogrammed by users. The third type of machine is manually controlled by the user without a PLC.

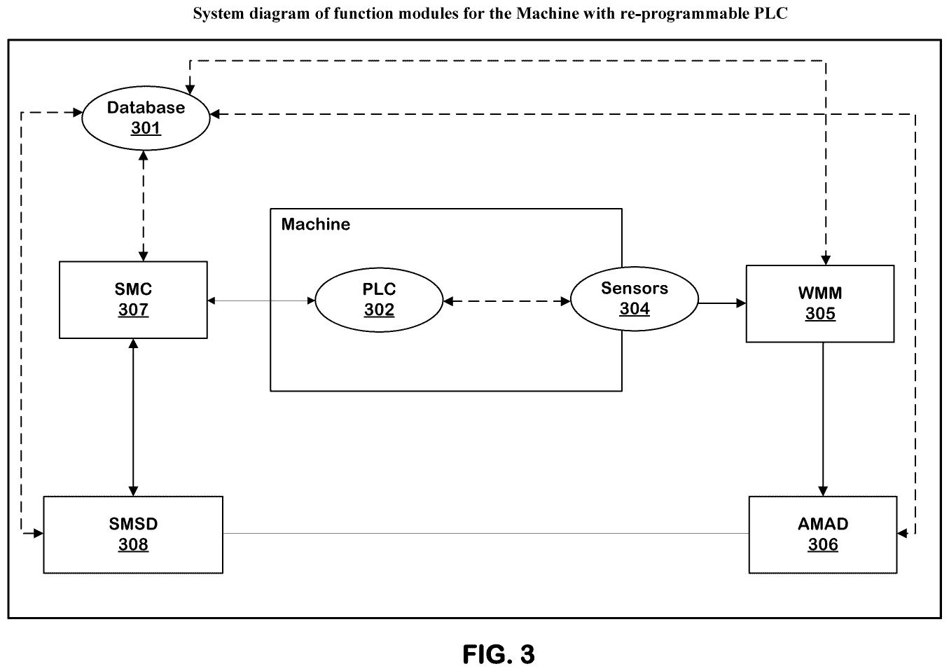

FIG. 3 shows an implementation of all four modules on the first type of machines. A WMM module 305 intakes the data collected from PLC and/or from sensors 304 directly. Based on those data, WMM 305 can use machine learning or deep learning models to detect interactive events and determine the operational modes (standby/active) of the machine in real-time. The WMM module 305 uploads sensor data, interactive events, and operational modes to database 301 for other function modules to use. AMAD module 306 uses outputs from WMM module 305, and the SOP information stored in database 301 to detect active mode anomalies and uploads anomalies to database 301. The SMC module 307 activates and deactivates the sleep mode according to the machine's operational modes determined by the WMM module 305. During sleep mode, SMC module 307 intakes the sensors data from the machine's PLC 302 and sends command to PLC 302 for controlling various components accordingly. An SMSD module 308 intakes the data that is collected and computed by SMC module 307 during the current sleep mode and historical sleep modes to identify sleep mode anomalies. The SMSD module 308 also intakes the outputs of AMAD module 306 to determine the potential cause of sleep mode anomalies. In one implementation, the manufacturing machines can be equipped with a cryopump. In this implementation, the SMSD module may send command to SMC module for conducting the cryopump self-regeneration.

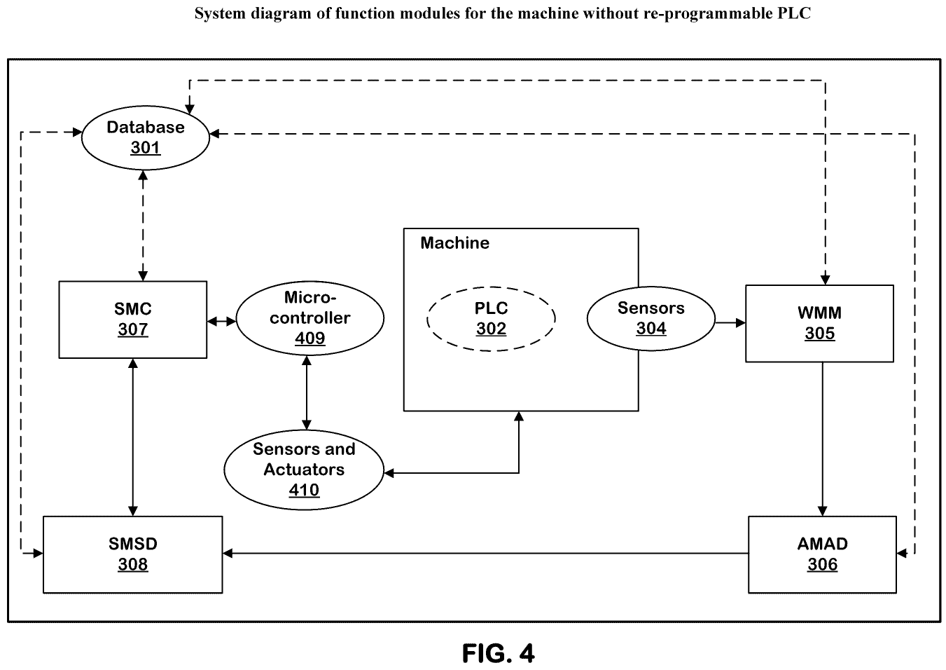

The implementation of the four function modules on the second and third types of machines are the same and are shown in FIG. 4. The implementation in FIG. 3 and FIG. 4 differs in how SMC module obtains the sensors data and controls the machine. For the first type of machines, their PLCs 302 are programmed to execute the SMC software, and the SMC module 307 can read the data from the PLC 302 and commands PLC 302 to control other components. On the second and third types of machines, the SMC software runs on an additional microcontroller 409, which reads the measurement from additional sensors 410 and controls the machine's components through additional actuators 410 such as relays.

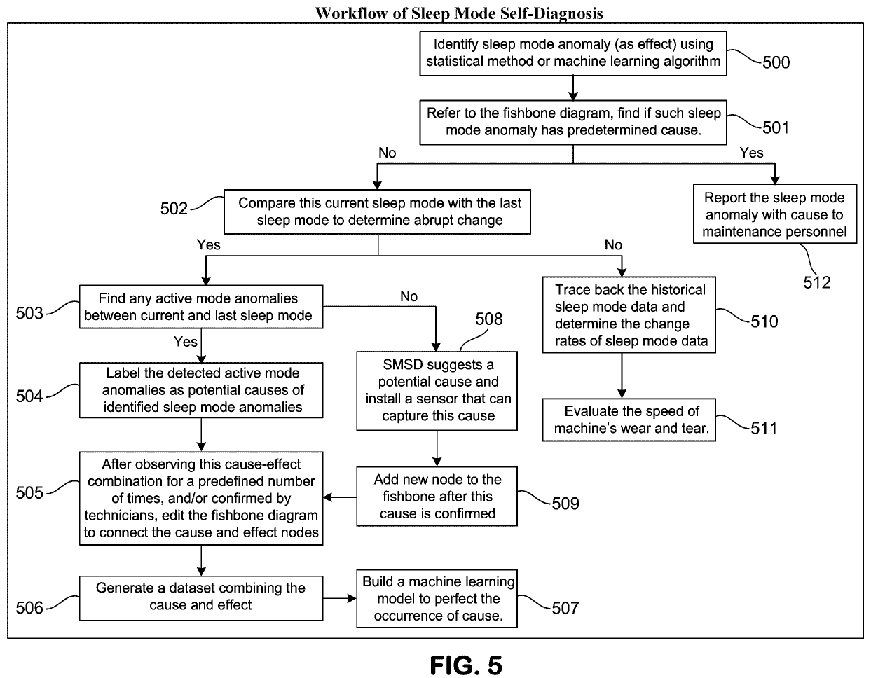

FIG. 5 presents process operations or process steps illustrating the logic implemented by SMSD module. As with all flow diagrams (or flow charts) herein, it will be appreciated that many of the operations can be combined, performed in parallel or performed in a different sequence without affecting the functions achieved. In some cases, as the reader will appreciate, a re-arrangement of operations will achieve the same results only if certain other changes are made as well. In other cases, as the reader will appreciate, a re-arrangement of operations will achieve the same results only if certain conditions are satisfied. Furthermore, it will be appreciated that the process flow diagram in FIG. 5 shows only operations that are pertinent to an understanding of the technology, and it will be understood that numerous additional operations for accomplishing other functions can be performed before, after and between those shown. In a step (or operation) 500, the SMSD module identifies sleep mode anomalies as effects using statistical method or machine learning algorithm. In a step (or operation) 501, the SMSD module includes logic to access the fishbone diagram to determine if such sleep mode anomalies have predetermined cause shown on the fishbone diagram. If the predetermined causes already exist, SMSD module reports the sleep mode anomalies and corresponding causes to maintenance personnel (operation 512). In a step (or operation) 502, if no predetermined cause is found, the SMSD module compares this current sleep mode with the last sleep mode to determine if there is any abrupt change in sleep mode data (operation 510). If abrupt change exists, in a step (or operation) 503, the SMSD module comprises logic to determine if any active mode anomalies have been detected between current and last sleep mode. In a step (or operation) 504, if there are active mode anomalies, SMSD module labels the detected active mode anomalies as potential causes of identified sleep mode anomalies. In a step (or operation) 505, after observing this cause-effect combination for a predefined number of times, and/or confirmed by technicians, SMSD module comprises logic to edit the fishbone diagram to connect the cause node and effect node. In a step (or operation) 506, the SMSD module generates a dataset combining the cause and effect. In a step (or operation) 507, a trained machine learning model can be used to predict the occurrence of cause and prevent it from happening so that the effect can be avoided. In a step (or operation) 508, if no active mode anomaly is detected, SMSD module suggests a potential cause with sensor that can capture this cause, and this new sensor may be installed. In a step (or operation) 509, a new node can be added to the fishbone diagram if the suggested cause is confirmed following the ways from the step (or operation) 503 to the step (or operation) 505. If no abrupt change in the sleep mode data is detected in the step (or operation) 502, the SMSD module may trace back the historical sleep mode data and determine the change rates of sleep mode data. In a step (or operation) 511, the SMSD module evaluates the speed of machine's wear and tear based on the change rates of sleep mode data. The SMSD module includes logic to determine an abrupt change in the sleep mode data such as pressure change rates, etc. For example, to determine if an abrupt change has occurred in the pressure change rate, the SMSD module compares the pressure change rate to a predefined threshold. If the pressure change rate is greater than the predefined threshold, the SMSD module determines that an abrupt change has occurred in the sleep mode data. One or more thresholds can be predefined for a particular sensor reading or data captured from a sensor in sleep mode. The SMSD module can define one or more levels of abrupt change by comparing the sleep mode data with the one or more predefined threshold values. Higher threshold values can identify a higher a severity level as compared to lower thresholds. Different maintenance procedures can be invoked for various levels of abrupt changes in the sleep mode data for a particular sensor reading.

### E-Beam Implementation

We now present another example implementation of the technology disclosed. In this implementation, the technology disclosed is used for monitoring performance and for predictive maintenance of an electron-beam evaporation machine. The electron-beam evaporation machine (hereinafter referred to as “e-beam”) is used for depositing metal film on samples such as silicon wafers. The e-beam's hardware is controlled by a PLC that can be reprogrammed. It has a vacuum system which follows the same configuration as FIG. 1. The detailed implementation of each function module on the e-beam will be explained in the following sections.

### Worker-Machine-Material Interaction Detection (WMM)

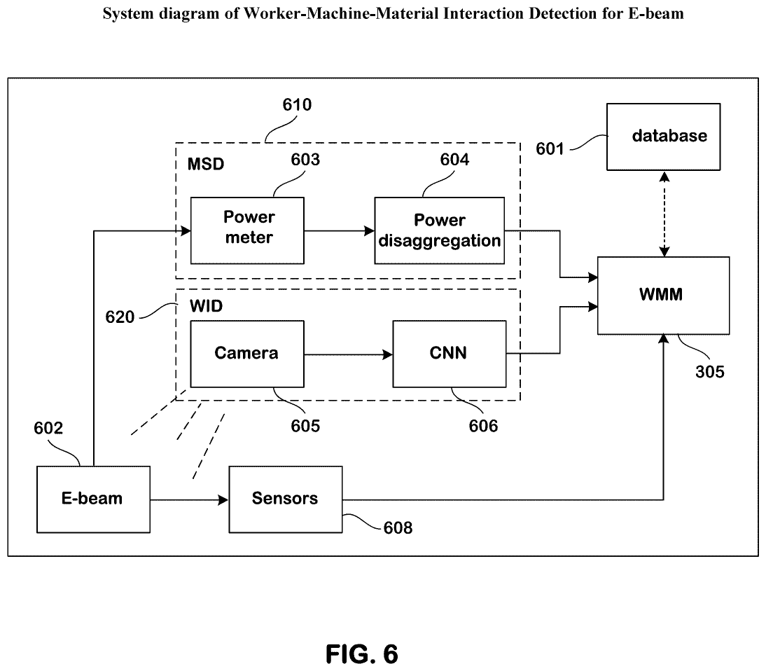

The WMM module (as shown in FIG. 6) consists of two sub-modules, namely Worker Interaction Detection and Machine State Detection (hereinafter referred to as “WID” and “MSD”, respectively).

The WID sub-module 620 uses a visual camera 605 as the sensor to capture image streams of the operating area of e-beam 602. The image streams are processed through machine learning algorithm, such as convolutional neural network (hereinafter referred to as “CNN”) 606, to detect the human skeletons of a worker present in the e-beam's operating area and classify the worker's action into several types, such as interacting with the keyboard, interacting with the process chamber, moving silicon wafers, and noninteraction. The WID sub-module 620 can detect the worker-machine and worker-material interactions to identify whether a worker is absent from the machine area, present in the machine area but without using the machine, or physically interacting with the machine and/or material.

The MSD sub-module 610 comprises logic to detect machine state changes to identify interactive events between the machine and material. The MSD sub-module 610 uses a power meter 603 connected to the main power supply of the e-beam 602 to monitor the real-time aggregated power signal of e-beam including multiple components, such as mechanical pump, cryopump, and electron gun. By applying the power disaggregation technique 604 to the aggregated main power signal, MSD sub-module 610 comprises logic to detect the operational states of e-beam's individual components. For example, the electron gun needs to be turned on during metal deposition, and the power consumption will increase accordingly. The MSD sub-module can detect that e-beam starts the deposition through the changes in power signal. Similarly, the MSD sub-module comprises logic to detect if the e-beam finishes the deposition, starts pumping down the chamber, or only maintains the chamber at base pressure.

Using the detection results provided by both WID and MSD sub-modules and the SOP stored in a database, WMM module 305 can determine whether the e-beam is in active or standby mode. The WMM module determines that the machine is in active mode if the WID sub-module determines that a worker is physically interacting with the machine, or if the MSD sub-module determines that any component is actively processing the material (also defined as active machine state), such as venting the chamber, pumping down the chamber, and using electron gun to evaporate metal. These two conditions do not have to be met simultaneously because the worker may not interact with the machine and leave the operating area during some of the manufacturing process. When the machine is determined to be in standby mode and a worker enters the operating area, WMM does not identify the machine as switching to active mode until the worker physically interacts with the machine, indicating the worker's intention to use it. During the active mode, all the detected interactive events are stored in a database 601 with time stamps. Thus, the sequence and the time interval information of operations are available for AMAD module. Note that the tasks or operations conducted by the machine in active mode are referred to as manufacturing tasks or manufacturing operations.

Besides the power signal and image streams that are used for determining operational modes, WMM module may also intakes other available outputs from various sensors 608 and store them in database 601 for AMAD module to use.

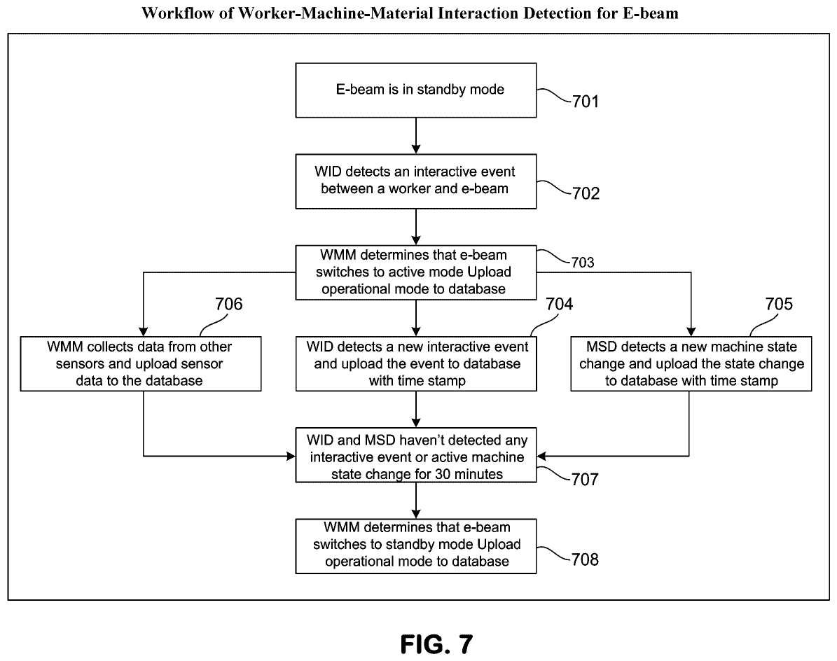

FIG. 7 presents a process flow diagram presenting examples of operations performed by a WMM module using finite state machine models to model the state of workers, machines, and materials. In a step (or operation) 701, e-beam is in standby mode. In a step (or operation) 702, WID sub-module detects an interactive event between a worker and e-beam and uploads this event to the database with a time stamp. In a step (or operation) 703, WMM module determines that the e-beam switches to the active mode and uploads this mode change to the database. Steps (or operations) 704, 705, and 706 can be performed simultaneously and can be repeated multiple times. In the step (or operation) 704, WID sub-module detects an interactive event between a worker and e-beam and uploads this timestamped event to the database. In a step (or operation) 705, MSD sub-module detects an interactive event between e-beam and materials (machine state change) and uploads this event to the database with a time stamp. In a step (or operation) 706 WMM module collects data from other sensors and uploads data to the database. In a step (or operation) 707, it is determined that WID and MSD submodules have not detected any interaction between a worker and e-beam or active machine state in the last 30 minutes. When the condition in operation 707 is true, in a step (or operation) 708, WMM module determines that e-beam switches to the standby mode and uploads this state change to the database.

### Active Mode Anomaly Detection (AMAD)

The AMAD module comprises logic to identify (or detect) anomalies that occur during the active mode. Detecting the anomalies in worker's operations can be achieved by comparing two inputs to find the deviation between them. The first input is the interactive events of the current operation that are detected by the WMM module. This information reflects the order in which workers perform the entire operation and how long each step lasts. The second input is the SOP-defined operation sequence and pre-characterized time intervals between each operation step that are stored in database. This information contains the correct sequence of operations that should be followed in order to accomplish a manufacturing task (or a manufacturing operation) with e-beam, and the time duration that each step normally takes if the worker conducts the process correctly. Machine learning algorithms may be used to capture deviation between those two inputs and identify anomalies.

The active mode anomalies that are not related to the worker's operations may be detected based on some process parameters, such as pressure, power, temperature, and vibration, that are measured by different sensors and are collected by WMM module. The AMAD module comprises logic to identify whether those parameters are out of their normal range through different methods that include but are not limited to standard deviation and linear classification. The AMAD module uploads all the detected active mode anomalies to the database.

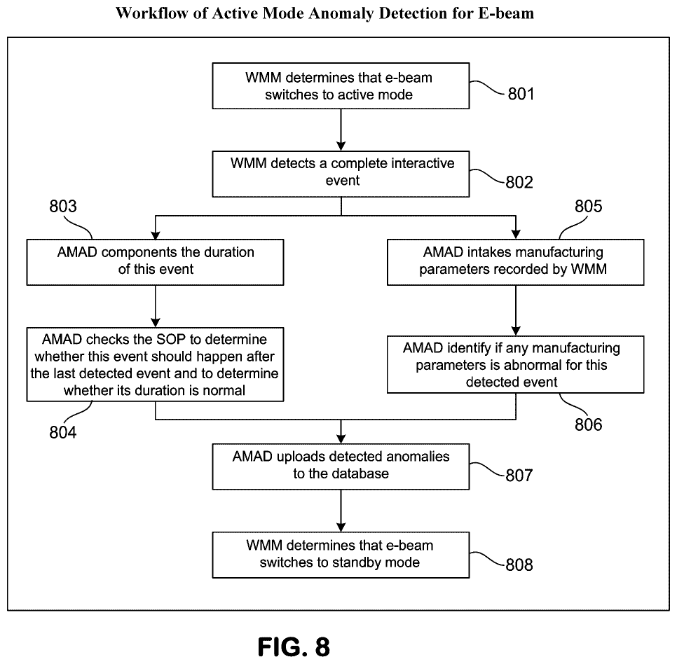

FIG. 8 shows an example of an AMAD module based on finite state machine model. In a step (or operation) 801, WMM module determines that e-beam switches to active mode. In a step (or operation) 802, the WMM module detects a complete interactive event. One example of a complete interactive event is that the WMM module identifies (or detects) the electron gun being turned on at the time t0, then at the later time t1, the WMM module detects the electron gun turns off indicating the event of depositing metal is complete. In a step (or operation) 803, AMAD module computes the duration of this complete event. In a step (or operation) 804, AMAD module checks the sequence of events that are defined in SOP to determine whether this detected event should occur immediately after the last detected event, and the AMAD module determines whether the duration of the detected event is normal. Steps (or operations) 805 and 806 may happen simultaneously with steps (or operations) 803 and 804. In steps (or operations) 805 and 806, AMAD detects whether all process parameters are within their normal range. In a step (or operation) 807, AMAD uploads anomalies of this interactive event to the database. Steps (or operations) from 802 to 807 may repeat until the WMM determines that e-beam switches to standby mode in step 808.

### Sleep Mode Control

The SMC module comprises logic to activate a sleep mode when the WMM module identifies that the e-beam is in standby mode to realize energy saving and provide information for diagnosis.

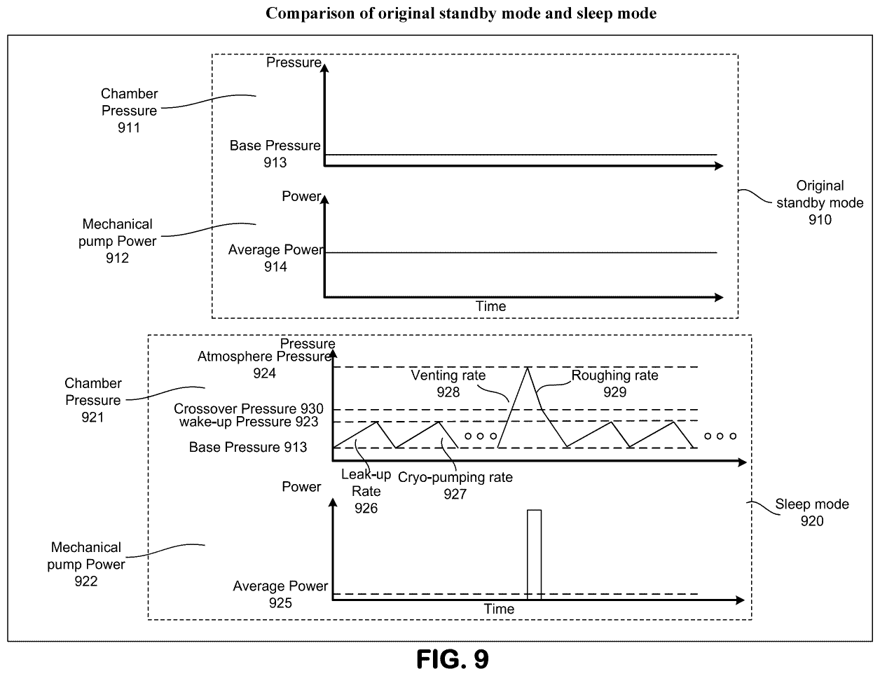

Comparisons of the chamber pressure and mechanical pump's power between the e-beam's original standby mode and the newly introduced sleep mode are shown in FIG. 9. The top two graphs illustrate changes over time in chamber pressure 911 and mechanical pump power 912 for original standby mode 910. The bottom two graphs illustrate changes over time in chamber pressure 921 and mechanical pump power 922 during sleep mode 920. During the e-beam's original standby mode 910, the chamber pressure 911 maintains at base pressure (˜10E-7 torr) 913 while the mechanical pump operates continuously with constant power consumption 914. The sleep mode introduced by the technology disclosed allows users to define a “wake-up pressure” 923 which is higher than the e-beam's base pressure 913 but within the low vacuum range so that the cryopump can operate. Here the wake-up pressure is set to 0.004 torr. In sleep mode 920, the high-vacuum valve closes at the base pressure 913 and opens at the wake-up pressure 923, maintaining the chamber pressure 921 within a predefined pressure range through the cryopump. After predefined cycles, the chamber vents to atmosphere pressure 921 followed by pumping down the chamber pressure to the crossover pressure 930 using the mechanical pump, then the roughing valve is closed and the mechanical pump turns off, and the chamber is pumped down back to the base pressure 913 using the cryopump. Since the mechanical pump is only turned on during roughing period in sleep mode, its average power consumption 925 is reduced compared to constant power consumption 914. The change rate of pressure as the chamber pressure rises from base pressure 913 to wake-up pressure 923 is calculated and defined as “leak-up rate” 926. The change rate of pressure as the chamber pressure decreases from wake-up pressure 923 to base pressure 913 is calculated and defined as “cryo-pumping rate” 927. The change rate of pressure as the chamber vents from base pressure 913 to atmosphere pressure 924 is calculated and defined as “venting rate” 923. The change rate of pressure as the chamber pressure decreases from atmosphere pressure 924 to crossover pressure 930 is calculated and defined as “roughing rate” 929. Those pressure change rates collected and calculated during sleep mode exclude the direct influence by the worker's operations and can reflect the machine's integrity. The above description illustrates various examples of diagnostic operations performed by the technology disclosed during the sleep mode. The examples of sleep mode diagnostic operations include increasing and/or decreasing the pressure in various components (or chambers) of the manufacturing machine. The sleep mode diagnostic operations include determining change rate of pressure in various components (or chambers) of the manufacturing machine. The sleep mode diagnostic operations include increasing and/or decreasing power consumption by various components of the manufacturing machine. The sleep mode diagnostic operations include comparing power consumption of various components of the manufacturing machine with their respective power consumption during other modes of operations such as standby mode and/or active mode.

In on implementation, the SMC module can be realized by logic implemented (e.g., using a software programmed) into the e-beam's PLC. The SMC module can have two inputs. The first input is the operational mode detection result from WMM module. This input indicates whether the e-beam enters standby mode whereas the SMC module can initiate sleep mode on the e-beam, or if the e-beam enters the active mode whereas the SMC module needs to deactivate the sleep mode until the worker's operation is finished and the e-beam switches to standby mode again. The second input is the chamber pressure. On the e-beam, the chamber pressure is measured by the pressure gauges installed in the vacuum system, and the measurements are transmitted to the e-beam's PLC. SMC can read the pressure measurements. The SMC module can generate two outputs. The first output is the command for opening/closing valves and turning on/off the mechanical pump. These commands are sent to the PLC when the corresponding threshold pressure is reached during sleep mode, then the PLC can control the valves and mechanical pump to vary the chamber pressure as shown in FIG. 9. The second output includes the leak-up rate 926, cryo-pumping rate 927, venting rate 928, and roughing rate 929, which are stored in a database.

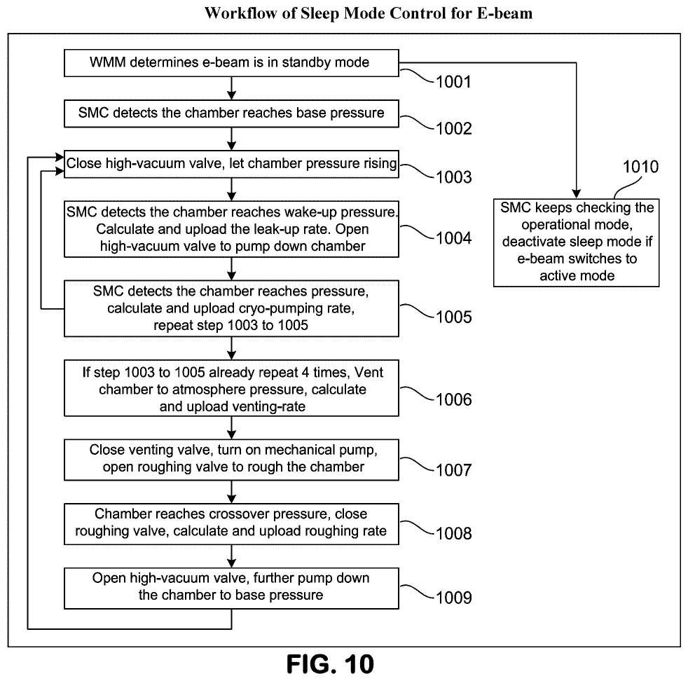

FIG. 10 illustrates a process flow diagram presenting a workflow of logic implemented by the SMC module. In a step (or operation) 1001, WMM module detects that the e-beam is in standby mode, and SMC initiates sleep mode and turns off mechanical pump. In a step (or operation) 1002, SMC module comprises logic to confirm that the chamber is at base pressure. In a step (or operation) 1003, the SMC module closes high-vacuum valve, allowing chamber pressure to rise. In a step (or operation) 1004, the chamber pressure reaches wake-up pressure, SMC module calculates the leak-up rate and opens high-vacuum valve to pump down chamber. In a step (or operation) 1005, SMC module detects the chamber reaches base pressure, then calculates the cryo-pumping rate. If steps (or operations) 1003, 1004, and 1005 had repeated four times, the process workflow goes to step 1006, otherwise the process starts from step (or operation) 1003. In step 1006, SMC vents the chamber to atmosphere pressure (or atmospheric pressure) and calculates venting-rate. In a step (or operation) 1007, SMC closes venting valve, turns on mechanical pump, and open roughing valve to start roughing the chamber. In a step (or operation) 1008, the chamber reaches crossover pressure, SMC closes roughing valve and calculates the roughing rate. In a step (or operation) 1009, SMC opens the high-vacuum valve to further pump down the chamber to base pressure. During sleep mode, SMC always checks the operational mode detected by WMM to deactivate the sleep mode if e-beam switches to active mode (operation 1010). The above description provides various examples of diagnostic operations implemented by the technology disclosed during sleep mode. Examples of diagnostic operations include increasing and/or decreasing the pressure in a component or chamber of the manufacturing machine to a pre-defined or desired level. Examples of diagnostic operations include opening and/or closing various valves in the manufacturing machine to increase and/or decrease pressure inside a component or chamber of the manufacturing machine. Examples of diagnostic operations include determining change rate of pressure inside a component or chamber of the manufacturing machine when one or more valves are opened or closed. Examples of diagnostic operations include determining the change of operational modes of a manufacturing machine from one mode to another mode. Examples of modes of operation of a manufacturing machine include active mode, standby mode and sleep mode, etc.

### Sleep Mode Self-Diagnosis

A fishbone diagram, also known as Ishikawa diagram or cause-and-effect diagram is a visualization tool used for identifying and categorizing possible causes of a problem or issue. A fishbone diagram includes clear statements of problems that need to be addressed (effect) and lists of all potential causes or factors that could contribute to the problem. The completion of a fishbone diagram usually relies on the knowledge and experience of human experts.

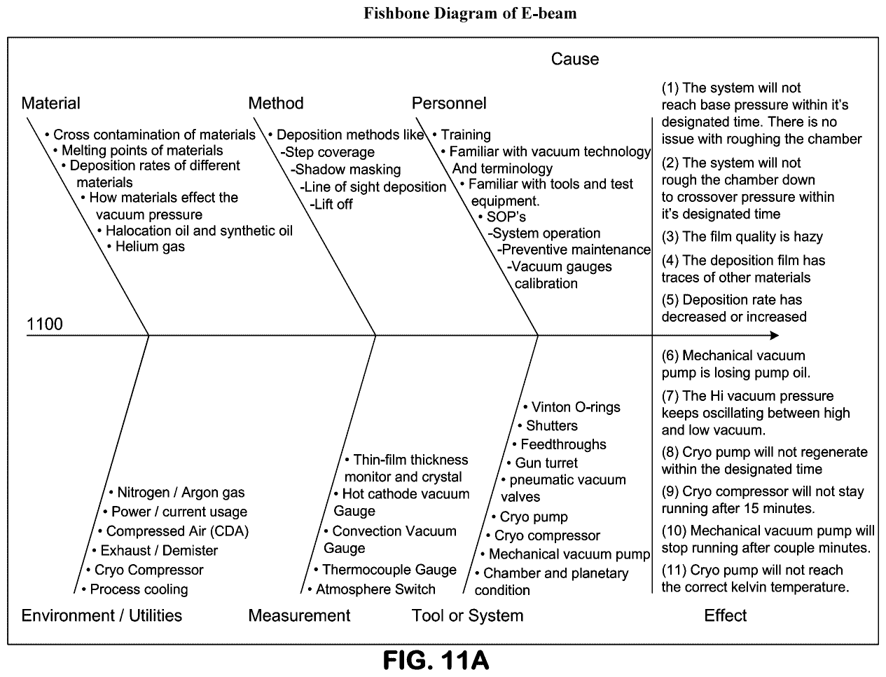

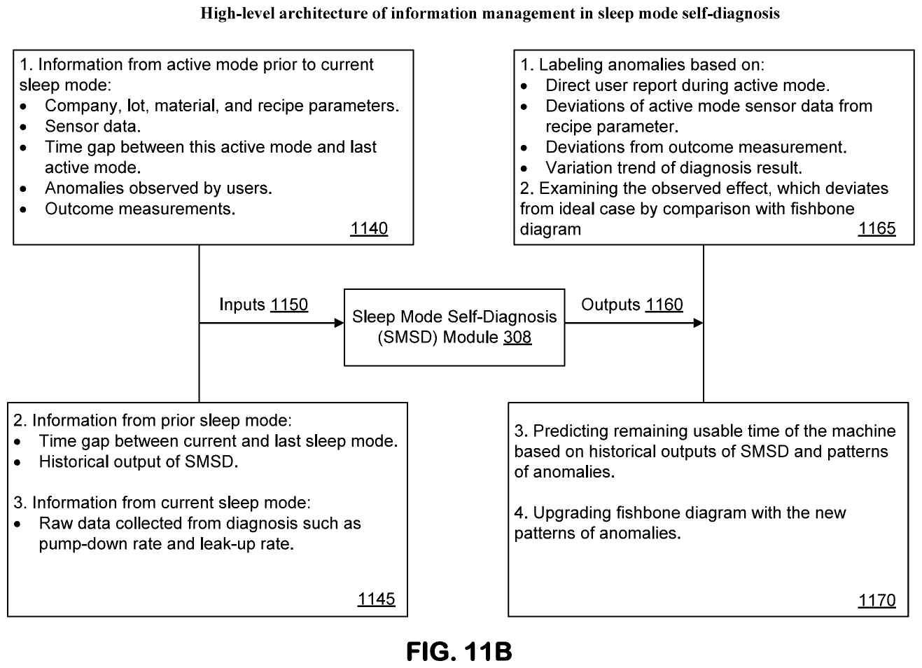

An example fishbone diagram of the e-beam is shown in FIG. 11A. When maintenance personnel observes an effect, the personnel can select multiple potential causes of this effect from the fishbone diagram, the personnel eliminate some potential causes by conducting different tests and finally find the true cause of the observed effect. For example, the maintenance personnel observe the effect that the chamber cannot reach the base pressure within its designated time, and the potential causes include 1. The cryopump performance decreased. 2. The chamber is leaking. 3. The chamber is contaminated so the outgassing rate is too high. The maintenance personnel may find that the cryopump head temperature is normal. Then the personnel may verify the cryopump can achieve base pressure by closing the high-vacuum valve and measuring the pressure inside the cryopump section. Thus, the potential cause 1 can be eliminated, and the true cause is related to the chamber. The personnel may test that the mechanical pump can pump down the chamber from the atmosphere pressure to crossover pressure within its designated time, indicating the chamber has no low-vacuum leaking. Then the personnel may use devices to verify that the chamber has no high-vacuum leaking. The potential cause 2 can be eliminated. Finally, the personnel may find the inner surface of the chamber is rough and identify that the chamber is contaminated, which is the true cause of the observed effect. The maintenance personnel can also check the operation log to determine whether workers used the wrong metal or set the deposition rate too high, which may cause chamber contamination.

The SMSD module comprises logic to provide a learning capability that can assist maintenance personnel in constructing the fishbone diagram, detecting effects, and narrowing down the potential causes of effects. The same example of chamber contamination that is mentioned above can be used to illustrate the function of SMSD module. SMSD module may detect the effect (i.e., sleep mode anomaly) by identifying the leak-up rate is higher than normal. SMSD module can determine that the roughing rate is normal which may indicate the chamber does not have low-vacuum leaking. SMSD module may find that the cryo-pumping rate is decreased, but the cryo-pump can still pump down the chamber to the base pressure. This suggests to the maintenance personnel that the cryopump efficiency may have very small influences in this scenario. SMSD module may detect that the leak-up rate gradually decreased over multiple leak-up cycles, which may indicate the cause is chamber contamination. Because the gas molecules trapped by contamination will be gradually pumped out and the outgassing rate will decrease over time. SMSD module may also check active mode anomalies and power data that are detected and collected during previous active modes to identify if any worker did not follow the SOP or set the deposition rate too high.

FIG. 11B illustrates an overview of the information management in Sleep Mode Self-Diagnosis (SMSD) including the key sources of input data and the outputs generated that are used for failure-cause identification and predictive maintenance. The inputs 1150 are provided to the sleep mode self-diagnosis (SMSD) module 308. The outputs 1160 are generated by the sleep mode self-diagnosis (SMSD) module 308. The SMSD module 308 comprises logic to integrate information from prior active wafer processing, prior diagnostic history, and the current sleep mode diagnosis. Examples of this information include recipe parameters, sensor readings, diagnostic results, and time gaps between mode cycles.

Based on the inputs (1150), the SMSD module 308 identifies deviations from expected performance, labels anomalies, and compares them to a known failure structure (existing fishbone diagram). Details of the inputs are provided in boxes labeled as 1140 and 1145 in FIG. 11B. The outputs (1160) include diagnostic results with detected anomalies, predicted remaining usable life of the machine, and updates to the knowledge graph of failure structure. Details of the outputs are provided in boxes labeled as 1165 and 1170.

The inputs (1150) are listed below:
1. Information from active mode prior to current sleep mode:
   a) Company, lot, material, and recipe parameters.
   b) Sensor data.
   c) Time gap between this active mode and last active mode.
   d) Anomalies observed by users.
   e) Outcome measurements.
2. Information from prior sleep mode:
   a) Time gap between current and last sleep mode.
   b) Historical output of SMSD module.
3. Information from current sleep mode:
   a) Raw data collected from diagnosis such as pump-down rate and leak-up rate.

The outputs (1160) are listed below:
1. Labeling anomalies based on:
   a) Direct user report during active mode.
   b) Deviations of active mode sensor data from recipe parameter.
   c) Deviations from outcome measurement.
   d) Variation trend of diagnosis result.
2. Examining the observed effect, which deviates from the ideal case by comparison with fishbone diagram.
3. Predicting remaining usable time of the machine based on historical outputs of SMSD module and patterns of anomalies.
4. Upgrading fishbone diagram with the new patterns of anomalies

The logic implemented by the SMSD module 308 allows using accumulated domain knowledge and historical data to not only identify known root causes of failure and degradation, but also to adaptively recognize new anomaly patterns and update failure models for future prediction and prevention.

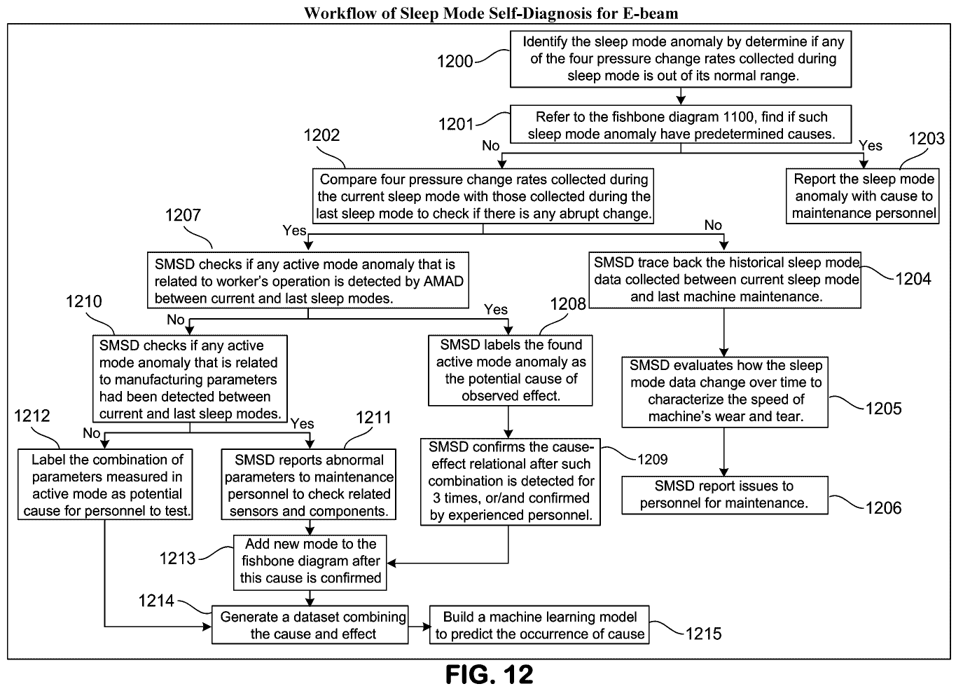

The workflow of SMSD module is shown in a process flow diagram in FIG. 12. In a step (or operation) 1200, SMSD module identifies if any of the four pressure change rates (leak-up rate, cryo-pumping rate, venting rate, and roughing rate) that computed by SMC module during the current sleep mode is out of its normal range (referred to as sleep mode anomaly). In a step (or operation) 1201, SMSD module comprises logic to scan the fishbone diagram 1100 (as shown in FIG. 11A) to find if the identified sleep mode anomaly has predetermined cause. If the sleep mode anomaly has been predetermined with causes, then the system includes logic to report the sleep mode anomaly with cause to maintenance personnel for further action (operation 1203). If the sleep mode anomaly has not been predetermined with causes from the fishbone diagram, then the process continues with an operation 1202. In a step (or operation) 1202, the SMSD module compares four rates collected during current sleep mode with the four rates collected during the last sleep mode to check if there is any abrupt change. The four rates may gradually change due to the normal wear and tear, an abrupt change may indicate that anomalies occurred in between two sleep modes. If such an abrupt change is detected, in a step (or operation) 1207, SMSD module checks if any active mode anomaly that is related to worker's operation had been detected by AMAD module between current and last sleep modes. Those anomalies may include but are not limited to starting deposition before chamber reaches predesignated pressure, using excessive deposition rate, and using wrong metal. In a step (or operation) 1208, the SMSD module comprises logic to label the found active mode anomaly as the potential cause of observed sleep mode anomaly. In a step (or operation) 1209, SMSD module comprises logic to confirm the detected active mode anomaly as the cause of observed effect after such combination had been detected three (i.e., 3) times, or/and confirmed by experienced personnel. The SMSD module can also check for the active mode anomaly related to the process parameters in a step (or operation) 1210. In a step (or operation) 1211, SMSD module reports abnormal process parameters to maintenance personnel for testing whether sensors are accurate and whether the machine's components breakdown and cause the effect In a step (or operation) 1212, if all sensors are outputting accurate measurements and all parameters are within the normal range during the manufacturing tasks that occurred between two sleep mode, SMSD module comprises logic to label the combination of parameters used in specific manufacturing task as the potential cause allowing the technician to test. Once a new true cause is determined, SMSD module adds new cause-effect correlation in the fishbone diagram (step 1213). In step 1214 and 1215, the SMSD module comprises logic to generate a dataset combining all the determined causes and effects and used to train the machine learning model for predicting the occurrence of cause. If no abrupt change is detected in step 1202, the SMSD module can trace back the historical data of four rates that were collected in all the sleep modes since last machine maintenance in a step (or operation) 1204. In a step (or operation) 1205, the SMSD module comprises logic to evaluate the changes in four rates over time to characterize the speed of machine's wear and tear. In a step (or operation) 1206, SMSD module reports issues to personnel for maintenance.

Sleep Mode Self-Diagnosis module also enables an automated cryopump self-regeneration. Cryopump regeneration is the process of warming a cryopump to room temperature or higher to release trapped gases. This process involves converting the condensed gases on the cryopanels back into a gaseous state, which are then evacuated by the cryopump's backing pump. The regeneration ensures the cryopump can continue to operate efficiently. The technology disclosed can trigger cryopump self-regeneration either by the temperature threshold or the result of sleep mode self-diagnosis. If the machine has a temperature gauge monitoring the temperature of cryopump head, the SMC module can perform the cryopump self-regeneration during the sleep mode when the temperature of cryopump head is higher than the threshold, indicating cryopump efficiency degraded. For the machine without temperature gauge, the cryopump self-regeneration can be triggered if SMSD module determines the cryopump efficiency is decreased, then SMSD module will send the command for performing cryopump self-regeneration to the SMC module. Then the SMC module will ask the e-beam's PLC to conduct the regeneration during the sleep mode. The technology disclosed includes logic to perform various diagnostic operations (such as cryopump regeneration) during sleep mode to improve the performance of various components of the manufacturing machine. Examples of diagnostic operations also include performing various types of maintenance operations to increase the efficiency of the various components of the manufacturing machine. The technology disclosed can not only determine issues in performance of components of the manufacturing machine during sleep mode but also includes logic to automatically execute one or more maintenance procedures to fix these issues and improve the performance of the manufacturing machine.

### Example Implementation Using Machine Learning for Sleep Mode Diagnostic Operations

An example of using sleep mode operation to achieve self-diagnosis is illustrated on a semiconductor manufacturing machine. It involves two major modules, the Sleep Mode Control (SMC) module and Sleep Mode Self-Diagnosis (SMSD) module. In one implementation, a multi-class machine learning classifier is used to validate the feasibility of identifying root causes of degradation in an electron beam evaporation system through sleep mode diagnostic operations. A diagnostic operation is implemented during the sleep mode of the system. During this mode, the system collected four pressure-based measurements: the roughing rate, cryopump pump-down rate, leak-up rate at crossover pressure, and leak-up rate at base pressure.

To validate this approach, seven controlled test cases representing different machine conditions were created:
Case 1: Contaminated chamber with N₂ venting (metal residues present).
Case 2: Contaminated chamber with CDA venting.
Case 3: Contaminated chamber with room air venting.
Case 4: Cleaned chamber with N₂ venting.
Case 5: Cleaned chamber, opened before diagnosis, with N₂ venting.
Case 6: Cleaned chamber, cooling water on, with N₂ venting.
Case 7: Cleaned and opened chamber, cooling water on, with N₂ venting.

The following scenarios were designed to simulate:
Evaporation residue contamination (Case 1 vs. Case 4),
Venting line variability and leak detection (Case 1, 2, and 3),
Chamber contamination due to ambient exposure (Case 4 vs. Case 5),
Temperature-induced effects (Case 6),
Condensation presence (Case 7).

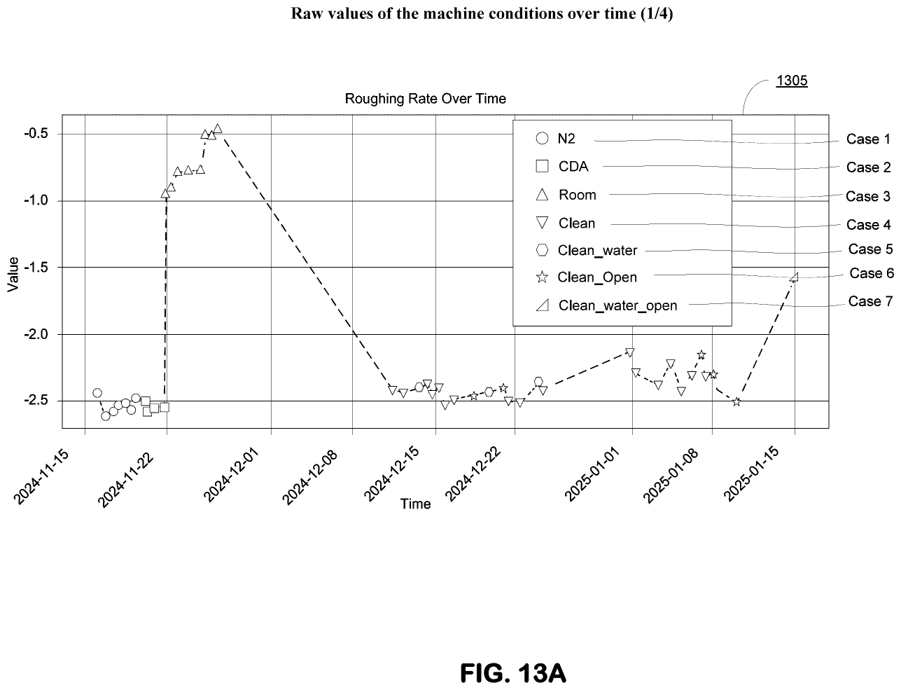

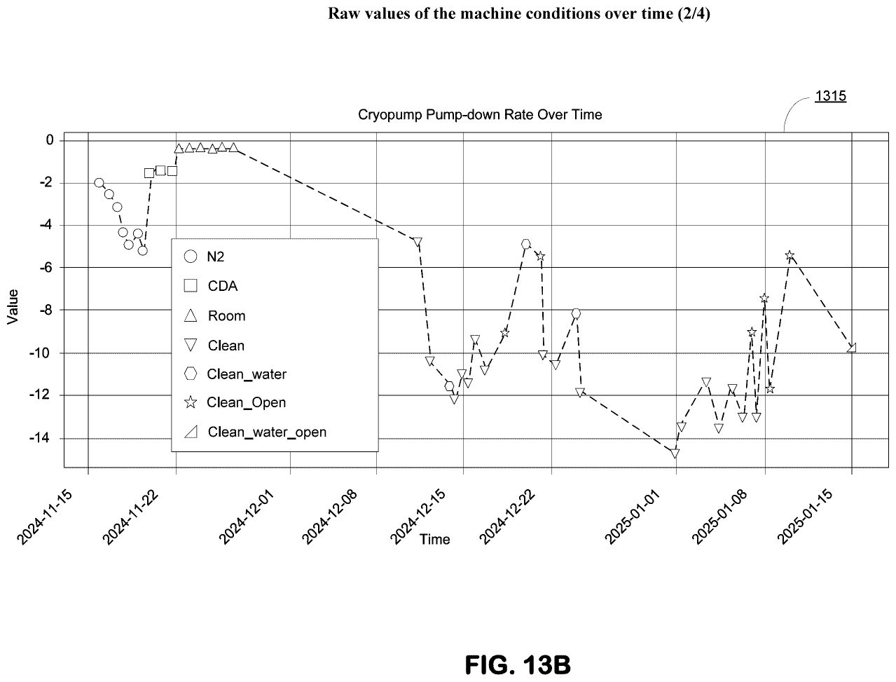

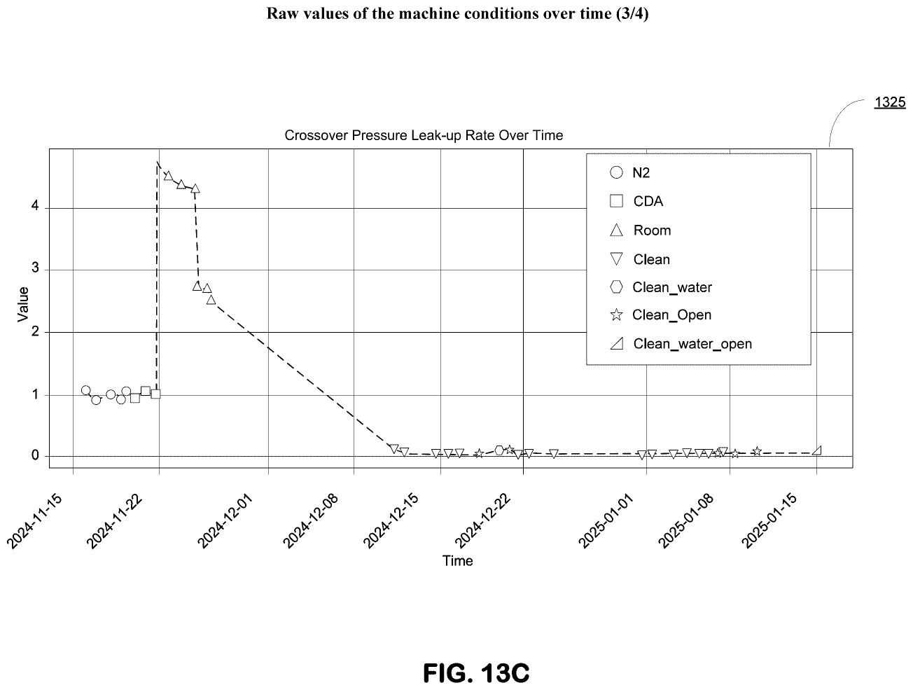

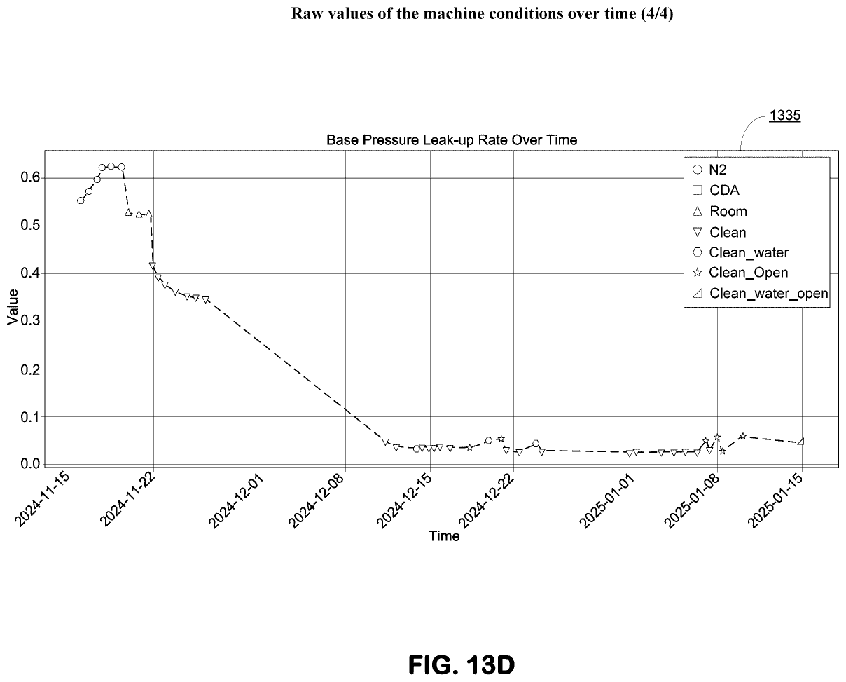

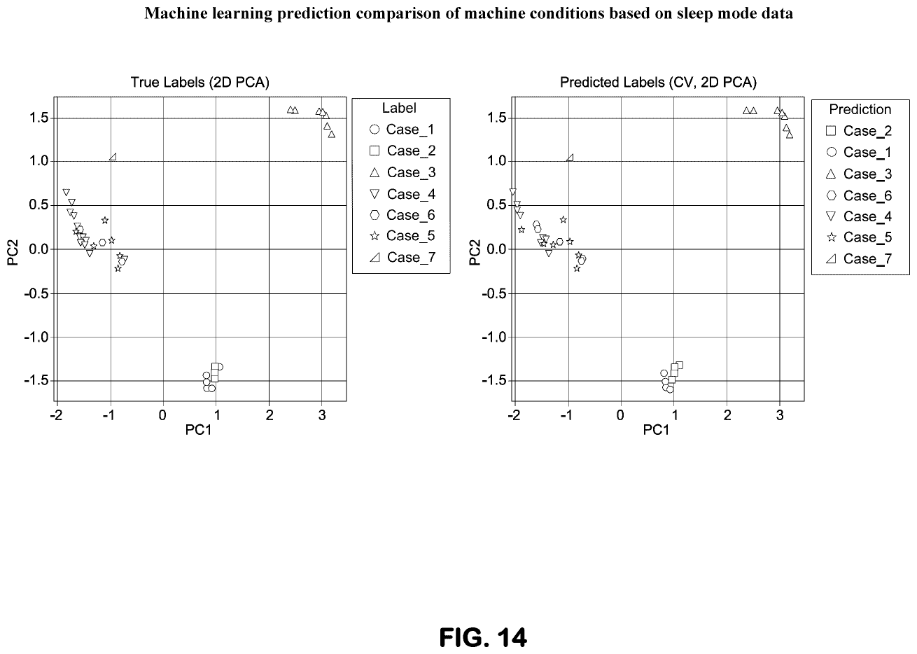

The raw data values for machine conditions over time are shown in FIGS. 13A, 13B, 13C and 13D. The raw data presented in graphs in FIGS. 13A, 13B, 13C and 13D correspond to seven cases listed above. A legend in graph 1305 in FIG. 13A shows mapping of the seven cases to the various data illustrated in the graph 1305. The data in graph 1315 (FIG. 13B), graph 1325 (FIG. 13C) and graph 1335 (FIG. 13D) illustrate raw data of machine conditions over time related to the seven cases listed above. The raw data, as shown in FIGS. 13A, 13B, 13C and 13D, includes four features collected during sleep mode self-diagnosis in different test cases and time. These four features include mechanical pump pump-down rate (referred to as roughing rate), cryopump pump-down rate, leak-up rate at low-vacuum crossover pressure, and leak-up rate at high-vacuum base pressure. The four features vary under different test cases simulated chamber condition over time and form specific combinations, which can be classified by the machine learning model for characterizing chamber conditions and identifying root causes. FIG. 13A presents graph 1305 illustrating roughing rate over time for the seven use cases listed above. FIG. 13B presents graph 1315 illustrating cryopump pump-down rate over time for the seven use cases listed above. FIG. 13C presents graph 1325 illustrating crossover pressure leak-up rate over time for the seven use cases presented above. FIG. 13D presents graph 1335 illustrating base pressure leak-up rate over time for the seven use cases presented above. A machine learning classification model is trained using data collected from each scenario listed above. The feature space is standardized and reduced using Principal Component Analysis (PCA) for visualization and interpretability. A Random Forest classifier is trained on class-balanced data using Random Oversampling and achieved 96% accuracy under 5-fold cross-validation across all test cases. Visualization of the classification results in PCA-reduced space confirmed clearly separated clusters corresponding to each physical scenario in FIG. 14.

This example validates the feasibility of embedding a machine learning-based diagnostic mode into semiconductor manufacturing equipment. It demonstrates how idle-time sensing and classification can be used to identify process degradation and environmental anomalies with high accuracy, enabling root cause detection in a manner analogous to traditional fishbone analysis but fully automated and data-driven.

### Example: Machine Condition Tracking for Predictive Maintenance and Self-Diagnosis

In one implementation, a diagnostic operation in sleep mode is executed on an electron beam evaporation system to collect machine condition data during inactive periods between active mode evaporation processes. The diagnostic operation is configured to automatically collect two vacuum-related metrics: (1) the leak-up rate at base pressure, which reflects whether or not the vacuum chamber integrity is compromised, and (2) the cryopump pump-down rate, which indicates operational efficiency of cryopump.

Between diagnostic cycles, different evaporation recipes are applied. These recipes vary in parameters such as material type, evaporation time, thickness, and power level. Some recipes resulted in effects that are recoverable by continuing to pump the chamber, while others caused persistent changes, including contamination accumulation, gas adsorption, and/or altered thermal conditions. These changes contributed incrementally to the degradation in the system's vacuum performance.

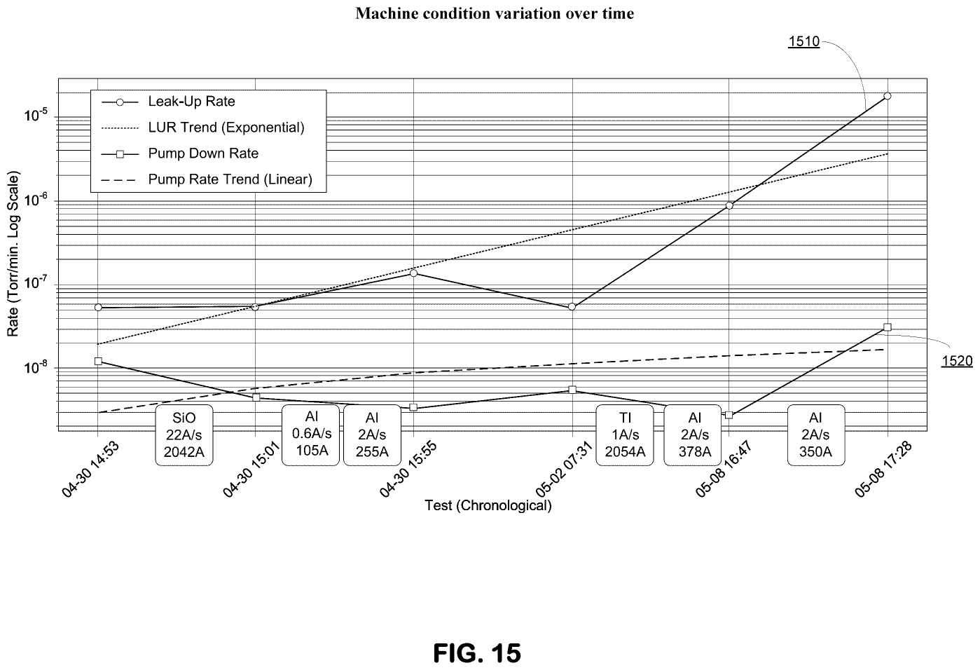

A time-sequenced plot of the diagnostic data, shown in FIG. 15, reveals that the leak-up rate (represented by a graphical plot 1510) increased exponentially across consecutive evaporation cycles, while the cryopump pump-down rate (represented by a graphical plot 1520) exhibits a declining trend, indicating slower vacuum recovery over time. These changes were observed to correlate with specific recipe types and accumulated process exposure.

To attribute the observed degradation to specific evaporation processes, interactive causality modeling can be applied. In this context, each evaporation operation acts as an independent causal event whose effects may persist and interact with subsequent events over time. Each process introduces a measurable change in machine condition, and the extent to which that effect continues is referred to as its interaction time. By analyzing the duration and decay characteristics of each recipe's effect—quantified as its interaction time—the system can determine how long a particular process continues to influence downstream machine behavior.

A prior causal relationship is established between the effect, where the leak-up rate increases, and the cause which are the prior recipes run in between. The identified effects, which are the increasing trends of leak-up rate, indicate the occurrence of causes. For example, a titanium (Ti) recipe may cause the leak-up rate to increase to a certain level. Its reciprocal relationship is then to help find out the cause for the diagnosis of the observed vacuum system efficiency degradation.

This causality-aware mapping of degradation trajectories enables more accurate forecasting of the remaining usable runtime before the system crosses a defined performance threshold. By continuously tracking the sequence and intensity of past evaporation activities and their residual effects, the system supports proactive, recipe-aware, and data-driven maintenance planning. This includes triggering maintenance alerts based not only on current measurement but also on predicted future degradation inferred from cumulative operation history. The result is an intelligent predictive maintenance strategy capable of reducing unplanned downtime and extending machine lifetime.

The technology disclosed includes logic to use trained machine learning models to raw data during sleep mode of the manufacturing machine. The technology disclosed can apply various recipes in between sleep modes of the manufacturing machine as described above to determine degradation in performance of various components of the manufacturing machine. A causality-aware mapping of the degradation then allows determination of the root causes of the degradation of performance of various components of the manufacturing machine. The technology disclosed also allows determination of usable runtime of a particular component of the manufacturing machine before the performance of the manufacturing machine crosses a predefined threshold. The technology disclosed therefore, allows determination of the time (or date) in future prior to which a particular component needs to be serviced and/or replaced to avoid failure of the manufacturing machine and/or degradation of the performance of the manufacturing machine. The diagnostic operations executed by the technology disclosed therefore, include the use of machine learning models to determine potential failure (or degradation in performance) of various components of the manufacturing machine. Diagnostic operations can also determine usable life (in number of operational hours, operational days, etc.) of various components of the manufacturing machine, allowing proactive servicing and/or replacement of the components to avoid potential machine failure and/or degradation in performance of the manufacturing machine.

### Technical Benefits and Advantages

Enhanced Maintenance Efficiency: The incorporation of machine learning and industry IoT technologies enables real-time monitoring and self-diagnosis during sleep modes. This facilitates predictive maintenance, allowing for timely identification of potential issues and reducing machine downtime.
Energy Savings: The implementation of novel sleep mode optimizes power management in mechanical pump-based vacuum systems. This reduces standby power consumption while maintaining process integrity, leading to significant energy savings.
Personalized Training: The system provides valuable insights for personalized training by identifying deviations from expected operations. This helps operators handle processes more effectively, enhancing overall operational performance.
Continuous Improvement: Integration of data from different operational modes allows for correlation between abnormal operations detected during active mode and machine performance degradation observed during sleep mode self-diagnosis. This facilitates continuous improvement of manufacturing processes, ensuring sustained efficiency and productivity over time.
Adaptability to Various Machines: This technology disclosed offers adaptability to a wide range of machines. It can seamlessly integrate with machines by programming the existing PLC. Additionally, for manually controlled machines or those where the PLC cannot be modified, the same benefits can be achieved with minimal additional hardware. This approach ensures compatibility without altering the original hardware configuration of the machine. Such adaptability enhances its applicability across diverse manufacturing setups, making it versatile and usable in various industrial environments.

A functional prototype of this technology disclosed has been successfully developed and tested in two semiconductor manufacturing equipment to assess the effectiveness of the innovation. Two distinct implementation methods were evaluated across various machines: integration with the machine's existing Programmable Logic Controller (PLC) and incorporation of additional microcontrollers equipped with sensors and actuators.

We are continuously collecting data for machine learning algorithm training, allowing the proposed system to identify various machine failure scenarios and help users to locate the reason of failure more precisely.

### CLAUSES

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

One or more implementations and clauses of the technology disclosed, or elements thereof can be implemented in the form of a computer product, including a non-transitory computer readable storage medium with computer usable program code for performing the method steps indicated. Furthermore, one or more implementations and clauses of the technology disclosed, or elements thereof can be implemented in the form of an apparatus including a memory and at least one processor that is coupled to the memory and operative to perform exemplary method steps. Yet further, in another aspect, one or more implementations and clauses of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

The clauses described in this section can be combined as features. In the interest of conciseness, the combinations of features are not individually enumerated and are not repeated with each base set of features. The reader will understand how features identified in the clauses described in this section can readily be combined with sets of base features identified as implementations in other sections of this application. These clauses are not meant to be mutually exclusive, exhaustive, or restrictive; and the technology disclosed is not limited to these clauses but rather encompasses all possible combinations, modifications, and variations within the scope of the claimed technology and its equivalents.

Other implementations of the clauses described in this section can include a non-transitory computer readable storage medium storing instructions executable by a processor to perform any of the clauses described in this section. Yet another implementation of the clauses described in this section can include a system including memory and one or more processors operable to execute instructions, stored in the memory, to perform any of the clauses described in this section.

We disclose the following clauses:
1. A computer-implemented method of identifying degradation in performance of a manufacturing machine, including:
   sending a first data to the manufacturing machine, in response to receipt of a second data identifying a current state of the manufacturing machine as a standby mode, allowing the manufacturing machine to transition to a sleep mode wherein the manufacturing machine executes at least one predefined diagnostic operation (or diagnostic task) in the sleep mode;
   sending a third data to the manufacturing machine, upon transitioning of the manufacturing machine to the sleep mode, allowing the manufacturing machine to execute the at least one predefined diagnostic operation in the sleep mode;
   receiving a fourth data generated in response to the execution of the at least one predefined diagnostic operation by the manufacturing machine in the sleep mode; and
   identifying the degradation in performance of the manufacturing machine when a value of the fourth data is less than a lower boundary value of a predefined range of values for the fourth data or the value of the fourth data is greater than an upper boundary value of the predefined range of values for the fourth data.
2. The computer-implemented method of clause 1, wherein in the standby mode, the manufacturing machine is in an idle state awaiting an instruction to execute at least one manufacturing operation (or manufacturing task) and upon receiving the instruction to execute the at least one manufacturing operation, the manufacturing machine transitions from the standby mode to an active mode for executing the at least one manufacturing operation.
3. The computer-implemented method of clause 1, wherein the fourth data generated in response to the execution of the at least one predefined diagnostic operation by the manufacturing machine in the sleep mode is collected from at least one sensor installed on the manufacturing machine.
4. The computer-implemented method of clause 1, further including, sending a fifth data to the manufacturing machine in response to receipt of a sixth data from manufacturing machine identifying transition of the state of the manufacturing machine from the sleep mode to an active mode, wherein the fifth data deactivates the sleep mode of the manufacturing machine allowing the manufacturing machine to perform at least one manufacturing operation in the active mode.
5. The computer-implemented method of clause 2, further including:
   receiving, stored data as accessed stored data corresponding to the at least one manufacturing operation performed by the manufacturing machine in at least one active mode state preceding a current sleep mode state and succeeding an earlier sleep mode state prior to the current sleep mode state;
   identifying at least one active mode anomaly corresponding to the at least one manufacturing operation in the accessed stored data; and
   determining the at least one active mode anomaly as a potential cause of the degradation in performance of the manufacturing machine.
6. The computer-implemented method of clause 5, wherein the stored data corresponding to the at least one manufacturing operation is at least one of a power consumption data, pressure data, change rate of pressure data, noise data, vibration data, humidity data, gas flow rate data or type of material data.
7. The computer-implemented method of clause 5, wherein the identifying at least one active mode anomaly corresponding to the at least one manufacturing operation in the accessed stored data, further includes:
   matching a first sequence of segments corresponding to the manufacturing operation from the accessed stored data to a second sequence of segments from a standard operating procedure corresponding to the manufacturing operation,
      wherein a segment in the first sequence of segments identifies a completed task by the manufacturing machine in active mode and a segment in the second sequence of segments identifies a planned task in the standard operating procedure; and
   identifying at least one mismatch between the first sequence of segments and the second sequence of segments.
8. The computer-implemented method of clause 5, wherein the identifying the at least one active mode anomaly corresponding to the at least one manufacturing operation in the accessed stored data, further includes:
   matching respective time intervales of a first sequence of segments corresponding to the manufacturing operation from the accessed stored data to respective time intervales of a second sequence of segments from a standard operating procedure corresponding to the manufacturing operation; and
   identifying at least one mismatch between the respective time intervales of the first sequence of segments and the respective time intervales of the second sequence of segments.
9. The computer-implemented method of clause 1, further including:
   calculating change rate of pressure for a segment corresponding to a diagnostic operation in the sleep mode; and
   identifying a degradation in integrity (or a sleep mode anomaly) of the manufacturing machine when the change rate of pressure for the segment is less than a lower boundary value of a predefined range of values for the change rate of pressure for the segment or the change rate of pressure for the segment is greater than an upper boundary value of the predefined range of values for the change rate of pressure for the segment.
10. The computer-implemented method of clause 9, wherein the change rate of pressure is at least one of (1) a leak-up rate identifying a rate of increase of chamber pressure from a base pressure value to a wake-up pressure value, (2) a cryo-pumping rate identifying a rate of decrease of chamber pressure from the wake-up pressure value to the base pressure value, (3) a venting rate identifying a rate of increase of chamber pressure from the base pressure value to an atmospheric pressure value and (4) a roughing rate identifying a rate of decrease of chamber pressure from the atmospheric pressure value to a crossover pressure value.
11. The computer-implemented method of clause 10, further including:
   determining an abrupt change in the change rate of pressure for the segment corresponding to the diagnostic operation in the sleep mode when the change rate of pressure is greater than a predefined threshold; and
   identifying at least one active mode anomaly corresponding to at least one manufacturing operation performed by the manufacturing machine in at least one active mode state preceding a current sleep mode state and succeeding an earlier sleep mode state; and
   determining the at least one active mode anomaly as a potential cause of the sleep mode anomaly of the manufacturing machine.
12. A system including one or more processors coupled to memory, the memory loaded with computer instructions to identify degradation in performance of a manufacturing machine, the instructions, when executed on the processors, implement, actions comprising:
   sending a first data to the manufacturing machine, in response to receipt of a second data identifying a current state of the manufacturing machine as a standby mode, allowing the manufacturing machine to transition to a sleep mode wherein the manufacturing machine executes at least one predefined diagnostic operation (or diagnostic task) in the sleep mode;
   sending a third data to the manufacturing machine, upon transitioning of the manufacturing machine to the sleep mode, allowing the manufacturing machine to execute the at least one predefined diagnostic operation in the sleep mode;
   receiving a fourth data generated in response to the execution of the at least one predefined diagnostic operation by the manufacturing machine in the sleep mode; and
   identifying the degradation in performance of the manufacturing machine when a value of the fourth data is less than a lower boundary value of a predefined range of values for the fourth data or the value of the fourth data is greater than an upper boundary value of the predefined range of values for the fourth data.
13. The system of clause 12, wherein in the standby mode, the manufacturing machine is in an idle state awaiting an instruction to execute at least one manufacturing operation (or manufacturing task) and upon receiving the instruction to execute the at least one manufacturing operation, the manufacturing machine transitions from the standby mode to an active mode for executing the at least one manufacturing operation.
14. The system of clause 12, wherein the fourth data generated in response to the execution of the at least one predefined diagnostic operation by the manufacturing machine in the sleep mode is collected from at least one sensor installed on the manufacturing machine.
15. The system of clause 12, further implementing actions comprising, sending a fifth data to the manufacturing machine in response to receipt of a sixth data from manufacturing machine identifying transition of the state of the manufacturing machine from the sleep mode to an active mode, wherein the fifth data deactivates the sleep mode of the manufacturing machine allowing the manufacturing machine to perform at least one manufacturing operation in the active mode.
16. The system of clause 13, further implementing actions comprising:
   receiving, stored data as accessed stored data corresponding to the at least one manufacturing operation performed by the manufacturing machine in at least one active mode state preceding a current sleep mode state and succeeding an earlier sleep mode state prior to the current sleep mode state;
   identifying at least one active mode anomaly corresponding to the at least one manufacturing operation in the accessed stored data; and
   determining the at least one active mode anomaly as a potential cause of the degradation in performance of the manufacturing machine.
17. The system of clause 16, wherein the stored data corresponding to the at least one manufacturing operation is at least one of a power consumption data, pressure data, change rate of pressure data, noise data, vibration data, humidity data, gas flow rate data or type of material data.
18. The system of clause 16, wherein the identifying at least one active mode anomaly corresponding to the at least one manufacturing operation in the accessed stored data, further implementing actions comprising:
   matching a first sequence of segments corresponding to the manufacturing operation from the accessed stored data to a second sequence of segments from a standard operating procedure corresponding to the manufacturing operation,
      wherein a segment in the first sequence of segments identifies a completed task by the manufacturing machine in active mode and a segment in the second sequence of segments identifies a planned task in the standard operating procedure; and
   identifying at least one mismatch between the first sequence of segments and the second sequence of segments.
19. The system of clause 16, wherein the identifying the at least one active mode anomaly corresponding to the at least one manufacturing operation in the accessed stored data, further implementing actions comprising:
   matching respective time intervales of a first sequence of segments corresponding to the manufacturing operation from the accessed stored data to respective time intervales of a second sequence of segments from a standard operating procedure corresponding to the manufacturing operation; and
   identifying at least one mismatch between the respective time intervales of the first sequence of segments and the respective time intervales of the second sequence of segments.
20. The system of clause 12, further implementing actions comprising:
   calculating change rate of pressure for a segment corresponding to a diagnostic operation in the sleep mode; and
   identifying a degradation in integrity (or a sleep mode anomaly) of the manufacturing machine when the change rate of pressure for the segment is less than a lower boundary value of a predefined range of values for the change rate of pressure for the segment or the change rate of pressure for the segment is greater than an upper boundary value of the predefined range of values for the change rate of pressure for the segment.
21. The system of clause 20, wherein the change rate of pressure is at least one of (1) a leak-up rate identifying a rate of increase of chamber pressure from a base pressure value to a wake-up pressure value, (2) a cryo-pumping rate identifying a rate of decrease of chamber pressure from the wake-up pressure value to the base pressure value, (3) a venting rate identifying a rate of increase of chamber pressure from the base pressure value to an atmospheric pressure value and (4) a roughing rate identifying a rate of decrease of chamber pressure from the atmospheric pressure value to a crossover pressure value.
22. The system of clause 21, further implementing actions comprising:
   determining an abrupt change in the change rate of pressure for the segment corresponding to the diagnostic operation in the sleep mode when the change rate of pressure is greater than a predefined threshold; and
   identifying at least one active mode anomaly corresponding to at least one manufacturing operation performed by the manufacturing machine in at least one active mode state preceding a current sleep mode state and succeeding an earlier sleep mode state; and
determining the at least one active mode anomaly as a potential cause of the sleep mode anomaly of the manufacturing machine.
23. A non-transitory computer readable storage medium impressed with computer program instructions to identify degradation in performance of a manufacturing machine, the instructions, when executed on a processor, implement a method, comprising:
   sending a first data to the manufacturing machine, in response to receipt of a second data identifying a current state of the manufacturing machine as a standby mode, allowing the manufacturing machine to transition to a sleep mode wherein the manufacturing machine executes at least one predefined diagnostic operation (or diagnostic task) in the sleep mode;
   sending a third data to the manufacturing machine, upon transitioning of the manufacturing machine to the sleep mode, allowing the manufacturing machine to execute the at least one predefined diagnostic operation in the sleep mode;
   receiving a fourth data generated in response to the execution of the at least one predefined diagnostic operation by the manufacturing machine in the sleep mode; and
   identifying the degradation in performance of the manufacturing machine when a value of the fourth data is less than a lower boundary value of a predefined range of values for the fourth data or the value of the fourth data is greater than an upper boundary value of the predefined range of values for the fourth data.
24. The non-transitory computer readable storage medium of clause 23, wherein in the standby mode, the manufacturing machine is in an idle state awaiting an instruction to execute at least one manufacturing operation (or manufacturing task) and upon receiving the instruction to execute the at least one manufacturing operation, the manufacturing machine transitions from the standby mode to an active mode for executing the at least one manufacturing operation.
25. The non-transitory computer readable storage medium of clause 23, wherein the fourth data generated in response to the execution of the at least one predefined diagnostic operation by the manufacturing machine in the sleep mode is collected from at least one sensor installed on the manufacturing machine.
26. The non-transitory computer readable storage medium of clause 23, further including, sending a fifth data to the manufacturing machine in response to receipt of a sixth data from manufacturing machine identifying transition of the state of the manufacturing machine from the sleep mode to an active mode, wherein the fifth data deactivates the sleep mode of the manufacturing machine allowing the manufacturing machine to perform at least one manufacturing operation in the active mode.
27. The non-transitory computer readable storage medium of clause 24, implementing the method further comprising:
   receiving, stored data as accessed stored data corresponding to the at least one manufacturing operation performed by the manufacturing machine in at least one active mode state preceding a current sleep mode state and succeeding an earlier sleep mode state prior to the current sleep mode state;
   identifying at least one active mode anomaly corresponding to the at least one manufacturing operation in the accessed stored data; and
   determining the at least one active mode anomaly as a potential cause of the degradation in performance of the manufacturing machine.
28. The non-transitory computer readable storage medium of clause 27, wherein the stored data corresponding to the at least one manufacturing operation is at least one of a power consumption data, pressure data, change rate of pressure data, noise data, vibration data, humidity data, gas flow rate data or type of material data.
29. The non-transitory computer readable storage medium of clause 27, wherein the identifying at least one active mode anomaly corresponding to the at least one manufacturing operation in the accessed stored data, implementing the method further comprising:
   matching a first sequence of segments corresponding to the manufacturing operation from the accessed stored data to a second sequence of segments from a standard operating procedure corresponding to the manufacturing operation,
      wherein a segment in the first sequence of segments identifies a completed task by the manufacturing machine in active mode and a segment in the second sequence of segments identifies a planned task in the standard operating procedure; and
   identifying at least one mismatch between the first sequence of segments and the second sequence of segments.
30. The non-transitory computer readable storage medium of clause 27, wherein the identifying the at least one active mode anomaly corresponding to the at least one manufacturing operation in the accessed stored data, implementing the method further comprising:
   matching respective time intervales of a first sequence of segments corresponding to the manufacturing operation from the accessed stored data to respective time intervales of a second sequence of segments from a standard operating procedure corresponding to the manufacturing operation; and
   identifying at least one mismatch between the respective time intervales of the first sequence of segments and the respective time intervales of the second sequence of segments.
31. The non-transitory computer readable storage medium of clause 23, implementing the method further comprising:
   calculating change rate of pressure for a segment corresponding to a diagnostic operation in the sleep mode; and
   identifying a degradation in integrity (or a sleep mode anomaly) of the manufacturing machine when the change rate of pressure for the segment is less than a lower boundary value of a predefined range of values for the change rate of pressure for the segment or the change rate of pressure for the segment is greater than an upper boundary value of the predefined range of values for the change rate of pressure for the segment.
32. The non-transitory computer readable storage medium of clause 31, wherein the change rate of pressure is at least one of (1) a leak-up rate identifying a rate of increase of chamber pressure from a base pressure value to a wake-up pressure value, (2) a cryo-pumping rate identifying a rate of decrease of chamber pressure from the wake-up pressure value to the base pressure value, (3) a venting rate identifying a rate of increase of chamber pressure from the base pressure value to an atmospheric pressure value and (4) a roughing rate identifying a rate of decrease of chamber pressure from the atmospheric pressure value to a crossover pressure value.
33. The non-transitory computer readable storage medium of clause 32, implementing the method further comprising:
   determining an abrupt change in the change rate of pressure for the segment corresponding to the diagnostic operation in the sleep mode when the change rate of pressure is greater than a predefined threshold; and
   identifying at least one active mode anomaly corresponding to at least one manufacturing operation performed by the manufacturing machine in at least one active mode state preceding a current sleep mode state and succeeding an earlier sleep mode state; and
determining the at least one active mode anomaly as a potential cause of the sleep mode anomaly of the manufacturing machine.

### Computer System

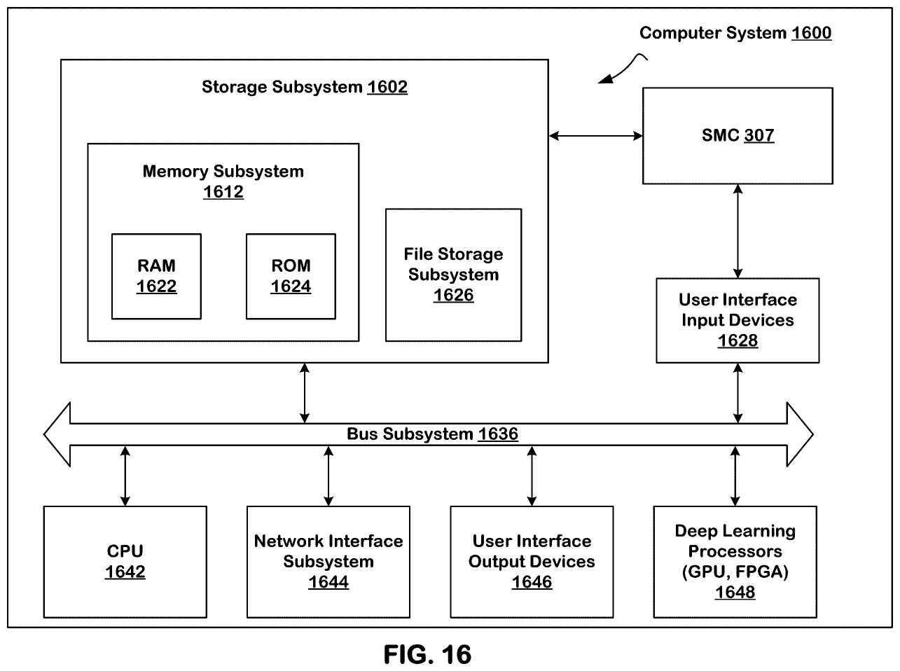

FIG. 16 shows an example computer system (also referred to as a computing node) 1600 that can be used to implement the technology disclosed. Computer system 1600 includes at least one central processing unit (CPU) 1642 that communicates with a number of peripheral devices via bus subsystem 1636. These peripheral devices can include a storage subsystem 1602 including, for example, memory devices and a file storage subsystem 1626, user interface input devices 1628, user interface output devices 1646, and a network interface subsystem 1644. The input and output devices allow user interaction with computer system 1600. Network interface subsystem 1644 provides an interface to outside networks, including an interface to corresponding interface devices in other computer systems.

In one implementation, the scheduling framework is communicably linked to the storage subsystem 1602 and the user interface input devices 1628.

User interface input devices 1628 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 1600.

User interface output devices 1646 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 1600 to the user or to another machine or computer system.

Storage subsystem 1602 stores programming and data constructs that provide the functionality of some or all of the modules and methods described herein. These software modules are generally executed by processors 1648.

Processors 1648 can be graphics processing units (GPUs), field-programmable gate arrays (FPGAs), application-specific integrated circuits (ASICs), and/or coarse-grained reconfigurable architectures (CGRAs). Processors 1648 can be hosted by a deep learning cloud platform such as Google Cloud Platform™, Xilinx™, and Cirrascale™ Examples of processors 1648 include Google's Tensor Processing Unit (TPU)™, rackmount solutions like GX4 Rackmount Series™, GX17 Rackmount Series™, NVIDIA DGX-1™, Microsoft' Stratix V FPGA™, Graphcore's Intelligent Processor Unit (IPU)™, Qualcomm's Zeroth Platform™ with Snapdragon Processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa V100s™, and others.

Memory subsystem 1612 used in the storage subsystem 1602 can include a number of memories including a main random access memory (RAM) 1622 for storage of instructions and data during program execution and a read only memory (ROM) 1624 in which fixed instructions are stored. A file storage subsystem 1626 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 1626 in the storage subsystem 1602, or in other machines accessible by the processor.

Bus subsystem 1636 provides a mechanism for letting the various components and subsystems of computer system 1600 communicate with each other as intended. Although bus subsystem 1636 is shown schematically as a single bus, alternative implementations of the bus subsystem can use multiple busses.

Computer system 1600 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 1600 depicted in FIG. 16 is intended only as a specific example for purposes of illustrating the preferred implementations of the present technology disclosed. Many other configurations of computer system 1600 are possible having more or less components than the computer system depicted in FIG. 16.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

FIG. 16 is a schematic of an exemplary computing node. The computer system (also referred to as a computing node) 1600 is only one example of a suitable computing node and is not intended to suggest any limitation as to the scope of use or functionality of embodiments described herein. Regardless, computing node 1600 is capable of being implemented and/or performing any of the functionality set forth hereinabove.

In the computing node 1600 there is a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server may be described in the general context of computer system-executable instructions, such as program modules, being executed by a computer system. Generally, program modules may include routines, programs, objects, components, logic, data structures, and so on that perform particular tasks or implement particular abstract data types. Computer system/server may be practiced in distributed computing environments where tasks are performed by remote processing devices that are linked through a communications network. In a distributed computing environment, program modules may be located in both local and remote computer system storage media including memory storage devices.

As shown in FIG. 16, computer system/server in computing node 1600 is shown in the form of a general-purpose computing device. The components of computer system/server may include, but are not limited to, one or more processors or processing units, a system memory, and a bus that couples various system components including system memory to processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server typically includes a variety of computer system readable media. Such media may be any available media that is accessible by computer system/server, and it includes both volatile and non-volatile media, removable and non-removable media.

System memory can include computer system readable media in the form of volatile memory, such as random access memory (RAM) and/or cache memory. Algorithm Computer system/server may further include other removable/non-removable, volatile/non-volatile computer system storage media. By way of example only, storage system can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus by one or more data media interfaces. As will be further depicted and described below, memory may include at least one program product having a set (e.g., at least one) of program modules that are configured to carry out the functions of embodiments of the disclosure.

Program/utility, having a set (at least one) of program modules, may be stored in memory by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments as described herein.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various implementations of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method of identifying degradation in performance of a manufacturing machine, including:
sending a first data to the manufacturing machine, in response to receipt of a second data identifying a current state of the manufacturing machine as a standby mode, allowing the manufacturing machine to transition to a sleep mode wherein the manufacturing machine executes at least one predefined diagnostic operation in the sleep mode;
sending a third data to the manufacturing machine, upon transitioning of the manufacturing machine to the sleep mode, allowing the manufacturing machine to execute the at least one predefined diagnostic operation in the sleep mode;
receiving a fourth data generated in response to the execution of the at least one predefined diagnostic operation by the manufacturing machine in the sleep mode; and
identifying the degradation in performance of the manufacturing machine when a value of the fourth data is less than a lower boundary value of a predefined range of values for the fourth data or the value of the fourth data is greater than an upper boundary value of the predefined range of values for the fourth data.

2. The computer-implemented method of claim 1, wherein in the standby mode, the manufacturing machine is in an idle state awaiting an instruction to execute at least one manufacturing operation and upon receiving the instruction to execute the at least one manufacturing operation, the manufacturing machine transitions from the standby mode to an active mode for executing the at least one manufacturing operation.

3. The computer-implemented method of claim 1, wherein the fourth data generated in response to the execution of the at least one predefined diagnostic operation by the manufacturing machine in the sleep mode is collected from at least one sensor installed on the manufacturing machine.

4. The computer-implemented method of claim 1, further including, sending a fifth data to the manufacturing machine in response to receipt of a sixth data from manufacturing machine identifying transition of the state of the manufacturing machine from the sleep mode to an active mode, wherein the fifth data deactivates the sleep mode of the manufacturing machine allowing the manufacturing machine to perform at least one manufacturing operation in the active mode.

5. The computer-implemented method of claim 2, further including:
receiving, stored data as accessed stored data corresponding to the at least one manufacturing operation performed by the manufacturing machine in at least one active mode state preceding a current sleep mode state and succeeding an earlier sleep mode state prior to the current sleep mode state;
identifying at least one active mode anomaly corresponding to the at least one manufacturing operation in the accessed stored data; and
determining the at least one active mode anomaly as a potential cause of the degradation in performance of the manufacturing machine.

6. The computer-implemented method of claim 5, wherein the stored data corresponding to the at least one manufacturing operation is at least one of a power consumption data, pressure data, change rate of pressure data, noise data, vibration data, humidity data, gas flow rate data or type of material data.

7. The computer-implemented method of claim 5, wherein the identifying at least one active mode anomaly corresponding to the at least one manufacturing operation in the accessed stored data, further includes:
matching a first sequence of segments corresponding to the manufacturing operation from the accessed stored data to a second sequence of segments from a standard operating procedure corresponding to the manufacturing operation,
wherein a segment in the first sequence of segments identifies a completed task by the manufacturing machine in active mode and a segment in the second sequence of segments identifies a planned task in the standard operating procedure; and
identifying at least one mismatch between the first sequence of segments and the second sequence of segments.

8. The computer-implemented method of claim 5, wherein the identifying the at least one active mode anomaly corresponding to the at least one manufacturing operation in the accessed stored data, further includes:
matching respective time intervales of a first sequence of segments corresponding to the manufacturing operation from the accessed stored data to respective time intervales of a second sequence of segments from a standard operating procedure corresponding to the manufacturing operation; and
identifying at least one mismatch between the respective time intervales of the first sequence of segments and the respective time intervales of the second sequence of segments.

9. The computer-implemented method of claim 1, further including:
calculating change rate of pressure for a segment corresponding to a diagnostic operation in the sleep mode; and
identifying a sleep mode anomaly of the manufacturing machine when the change rate of pressure for the segment is less than a lower boundary value of a predefined range of values for the change rate of pressure for the segment or the change rate of pressure for the segment is greater than an upper boundary value of the predefined range of values for the change rate of pressure for the segment.

10. The computer-implemented method of claim 9, wherein the change rate of pressure is at least one of (1) a leak-up rate identifying a rate of increase of chamber pressure from a base pressure value to a wake-up pressure value, (2) a cryo-pumping rate identifying a rate of decrease of chamber pressure from the wake-up pressure value to the base pressure value, (3) a venting rate identifying a rate of increase of chamber pressure from the base pressure value to an atmospheric pressure value and (4) a roughing rate identifying a rate of decrease of chamber pressure from the atmospheric pressure value to a crossover pressure value.

11. The computer-implemented method of claim 10, further including:
determining an abrupt change in the change rate of pressure for the segment corresponding to the diagnostic operation in the sleep mode when the change rate of pressure is greater than a predefined threshold; and
identifying at least one active mode anomaly corresponding to at least one manufacturing operation performed by the manufacturing machine in at least one active mode state preceding a current sleep mode state and succeeding an earlier sleep mode state; and
determining the at least one active mode anomaly as a potential cause of the sleep mode anomaly of the manufacturing machine.

12. A system including one or more processors coupled to memory, the memory loaded with computer instructions to identify degradation in performance of a manufacturing machine, the instructions, when executed on the processors, implement, actions comprising:
sending a first data to the manufacturing machine, in response to receipt of a second data identifying a current state of the manufacturing machine as a standby mode, allowing the manufacturing machine to transition to a sleep mode wherein the manufacturing machine executes at least one predefined diagnostic operation in the sleep mode;
sending a third data to the manufacturing machine, upon transitioning of the manufacturing machine to the sleep mode, allowing the manufacturing machine to execute the at least one predefined diagnostic operation in the sleep mode;
receiving a fourth data generated in response to the execution of the at least one predefined diagnostic operation by the manufacturing machine in the sleep mode; and
identifying the degradation in performance of the manufacturing machine when a value of the fourth data is less than a lower boundary value of a predefined range of values for the fourth data or the value of the fourth data is greater than an upper boundary value of the predefined range of values for the fourth data.

13. The system of claim 12, wherein in the standby mode, the manufacturing machine is in an idle state awaiting an instruction to execute at least one manufacturing operation and upon receiving the instruction to execute the at least one manufacturing operation, the manufacturing machine transitions from the standby mode to an active mode for executing the at least one manufacturing operation.

14. The system of claim 12, wherein the fourth data generated in response to the execution of the at least one predefined diagnostic operation by the manufacturing machine in the sleep mode is collected from at least one sensor installed on the manufacturing machine.

15. The system of claim 12, further implementing actions comprising, sending a fifth data to the manufacturing machine in response to receipt of a sixth data from manufacturing machine identifying transition of the state of the manufacturing machine from the sleep mode to an active mode, wherein the fifth data deactivates the sleep mode of the manufacturing machine allowing the manufacturing machine to perform at least one manufacturing operation in the active mode.

16. The system of claim 13, further implementing actions comprising:
receiving, stored data as accessed stored data corresponding to the at least one manufacturing operation performed by the manufacturing machine in at least one active mode state preceding a current sleep mode state and succeeding an earlier sleep mode state prior to the current sleep mode state;
identifying at least one active mode anomaly corresponding to the at least one manufacturing operation in the accessed stored data; and
determining the at least one active mode anomaly as a potential cause of the degradation in performance of the manufacturing machine.

17. A non-transitory computer readable storage medium impressed with computer program instructions to identify degradation in performance of a manufacturing machine, the instructions, when executed on a processor, implement a method, comprising:
sending a first data to the manufacturing machine, in response to receipt of a second data identifying a current state of the manufacturing machine as a standby mode, allowing the manufacturing machine to transition to a sleep mode wherein the manufacturing machine executes at least one predefined diagnostic operation in the sleep mode;
sending a third data to the manufacturing machine, upon transitioning of the manufacturing machine to the sleep mode, allowing the manufacturing machine to execute the at least one predefined diagnostic operation in the sleep mode;
receiving a fourth data generated in response to the execution of the at least one predefined diagnostic operation by the manufacturing machine in the sleep mode; and
identifying the degradation in performance of the manufacturing machine when a value of the fourth data is less than a lower boundary value of a predefined range of values for the fourth data or the value of the fourth data is greater than an upper boundary value of the predefined range of values for the fourth data.

18. The non-transitory computer readable storage medium of claim 17, implementing the method further comprising, sending a fifth data to the manufacturing machine in response to receipt of a sixth data from manufacturing machine identifying transition of the state of the manufacturing machine from the sleep mode to an active mode, wherein the fifth data deactivates the sleep mode of the manufacturing machine allowing the manufacturing machine to perform at least one manufacturing operation in the active mode.

19. The non-transitory computer readable storage medium of claim 17, implementing the method further comprising:
calculating change rate of pressure for a segment corresponding to a diagnostic operation in the sleep mode; and
identifying a degradation in integrity of the manufacturing machine when the change rate of pressure for the segment is less than a lower boundary value of a predefined range of values for the change rate of pressure for the segment or the change rate of pressure for the segment is greater than an upper boundary value of the predefined range of values for the change rate of pressure for the segment.

20. The non-transitory computer readable storage medium of claim 19, wherein the change rate of pressure is at least one of (1) a leak-up rate identifying a rate of increase of chamber pressure from a base pressure value to a wake-up pressure value, (2) a cryo-pumping rate identifying a rate of decrease of chamber pressure from the wake-up pressure value to the base pressure value, (3) a venting rate identifying a rate of increase of chamber pressure from the base pressure value to an atmospheric pressure value and (4) a roughing rate identifying a rate of decrease of chamber pressure from the atmospheric pressure value to a crossover pressure value.
